(19) United States
(12) Patent Application Publication
(10) Pub. No.: US 2020/0180935 A1
(43) Pub. Date: Jun. 11, 2020

(54) SYSTEM AND METHOD FOR FLUIDS MANAGEMENT

(71) Applicant: Beverage Metrics, Inc., Highlands Ranch, CO (US)

(72) Inventors: Martin Zumtobel, Highlands Ranch, CO (US); Werner Grunwald, Highlands Ranch, CO (US); Michael Gantner, Highlands Ranch, CO (US)

(21) Appl. No.: 16/608,641

(22) PCT Filed: Apr. 25, 2018
(86) PCT No.: PCT/US2018/029487

§ 371 Date: Oct. 25, 2019

Related U.S. Application Data
(60) Provisional application No. 62/489,862, filed on Apr. 25, 2017.

(51) Int. Cl. B67D 1/12; G06Q 10/08

(52) U.S. Cl. CPC B67D 1/12; G06Q 10/087

(57) ABSTRACT

A system, method, method for manufacturing, and apparatus, programmable instructions, computer-readable medium storing computer-implementable instructions, for managing the disbursement of fluids, including beverage pours, and information related thereto, is provided. The system includes a tag pack having a tag, including a circuit. The system includes a communications system between the tag circuit, a reader, a receiver/transmitter, and a secure, cloud-based analytical system.

### CROSS-REFERENCE TO RELATED APPLICATIONS

This application claims priority to U.S. Provisional Patent Application No. 62/489,862, filed on Apr. 25, 2017, and incorporates that application in its entirety by reference hereto.

### FIELD OF INVENTION

The present invention relates to a system, method, method for manufacturing, and apparatus, among other things, for managing the disbursement of fluids, including beverage pours, and information related thereto.

### RELATED INFORMATION

Various industries dispense fluids and require a system for accurately monitoring and tracking such dispensing. For example, the beverage and events industries lose real revenue due to inaccurate or false pours for customers, including free drinks for non-paying persons or improper beverage disbursement. Further, such non-revenue generating pours provide incorrect measurements and data for a business attempting to forecast inventory for the business or events.

Present solutions have been found to provide inaccurate and untenable solutions for measuring pours and monitoring same. For example, some systems track the weight of the fluids in the bottles, while others utilize a spray gun or other device to keep track of beverage pours. Further, such systems include a significant amount of manual labor to keep track of and weigh the beverage containers at the end of business periods.

Other solutions have provided RFID (radio frequency identification) data transmission systems, requiring local computation of the liquid pour system data and any analysis or reports related thereto. Such systems require a relatively expensive infrastructure, including, e.g., the installation of on-site readers and dedicated processing power at each business establishment, in order to generate and analyze the data from the system. Further, maintenance of such on-site systems provide an additional expense and time-consuming event. Such systems are not readily accessible to multiple entities, which could provide additional or remote monitoring and analysis.

In addition to the foregoing, the presently used data-generating processes appear to provide inaccurate data generation, due, e.g., to the switching of bottle sizes, being used with the same or similar type tagging electromechanical device.

Accordingly, there exists a need for an accurate and remote-accessible liquid dispensing monitoring system and data analysis regarding same to provide better forecasting of inventory.

### SUMMARY

Embodiments of the present invention provide an improved accuracy system and method for monitoring a liquid, e.g., beverage, dispensing system. Embodiments of the present invention provide for a data analysis system and method for forecasting inventory and determining faults in the system.

Embodiments of the present invention provide for an improved data-generating process, including an algorithm that tracks and takes into account several factors. In an embodiment, the improved data-generating process includes recognition and analysis of point of sale data reconciliation, inventory control mechanisms, financial information, and reorder data forecasting. Previous systems provide algorithms based simply on empirical data generation. With the embodiments of the present invention, a business can use analysis process to provide reports for customers on inventory, reorder and pour data. Further, embodiments of the present invention can provide information useful for market research companies and manufacturers to understand usage and effectiveness.

Embodiments of the present invention provide for a new type of electromechanical tag, which is smaller, elegant, and incorporates new technologies in measuring pours. In an embodiment, a tag incorporates use of infrared technology to measure bottle or pour data. In an embodiment, a tag is smaller and more elegant, thus providing a more aesthetic and pleasing look to the measuring sensor tag. In former systems, the tag was larger or cumbersome and often was placed inaccurately on the bottle due to the size and attachment capabilities of the tag. In an embodiment, the tag allows for infrared and other measurements, thus eliminating the previous need for manual switches.

Embodiments of the present invention provide for a Bluetooth® or low energy network accessing system, providing a much leaner and less expensive system. Embodiments of the present invention provide for analysis of generated data from the system in a local area network, a wide access network, the Internet and/or the Cloud. For example, in an embodiment where some or all of the data analysis is effected in the Cloud, this eliminates the previous need for on-site additional processing power capabilities and on-site or point of sale (POS) systems.

### BRIEF DESCRIPTION OF THE DRAWINGS

FIG. 1 shows an embodiment of the present invention.

FIG. 2 shows an embodiment of the present invention.

FIG. 3A shows an example embodiment of a tag of the present invention.

FIG. 3B shows an example embodiment of a tag of the present invention.

FIG. 3C shows an example embodiment of a tag of the present invention.

FIG. 4 shows an embodiment of the present invention.

FIG. 5A shows an example embodiment of a tag or tag pack of the present invention.

FIG. 5B shows an example embodiment of a tag or tag pack of the present invention.

FIG. 5C shows an example embodiment of a tag or tag pack of the present invention.

FIG. 5D shows an example embodiment of a tag or tag pack of the present invention.

FIG. 5E shows an example embodiment of a tag or tag pack of the present invention.

FIG. 5F shows an example embodiment of a tag or tag pack of the present invention.

FIG. 5G shows an example embodiment of a tag or tag pack of the present invention.

FIG. 5H shows an example embodiment of a tag or tag pack of the present invention.

FIG. 5I shows an example embodiment of a tag or tag pack of the present invention.

FIG. 6A shows an example embodiment of a tag pack of the present invention.

FIG. 6B shows an example embodiment of a tag pack of the present invention.

FIG. 6C shows an example embodiment of a tag pack of the present invention.

FIG. 6D shows an example embodiment of a tag pack of the present invention.

FIG. 6E shows an example embodiment of a tag pack of the present invention.

FIG. 6F shows an example embodiment of a tag pack of the present invention.

FIG. 6G shows an example embodiment of a tag pack of the present invention.

FIG. 6H shows an example embodiment of a tag pack of the present invention.

FIG. 6I shows an example embodiment of a tag pack of the present invention.

FIG. 6J shows an example embodiment of a tag pack of the present invention.

FIG. 6K shows an example embodiment of a tag pack of the present invention.

FIG. 7A shows a 5 mm spout example used in an embodiment of the present invention.

FIG. 7B shows a 7 mm spout example used in an embodiment of the present invention.

FIG. 8 shows a table of angle zones of a tag or sensor disposed on a liquid container according to an embodiment of the present invention.

FIG. 9 shows a schematic sketch of a cylindrical bottle according to an embodiment of the present invention.

FIG. 10 shows a schematic sketch of a rectangular bottle according to an embodiment of the present invention.

FIG. 11 shows example statistical quantities of beverage pours according to an embodiment of the present invention.

FIG. 12 shows example statistical quantities of beverage pours according to an embodiment of the present invention.

FIG. 13A shows a schematic sketch of a wine bottle used without a spout according to an embodiment of the present invention.

FIG. 13B shows a schematic sketch of a wine bottle used without a spout according to an embodiment of the present invention.

FIG. 14 shows example outflow velocities for beverage pours from a bottle without a spout such as that shown in FIGS. 13A, 13B according to an embodiment of the present invention.

FIG. 15 shows example statistical information on experimental beverage pours from a bottle without a spout according to an embodiment of the present invention.

FIG. 16A shows an example embodiment of a tag housing according to an embodiment of the present invention.

FIG. 16B shows an example embodiment of a tag housing according to an embodiment of the present invention.

FIG. 16C shows an example embodiment of a tag housing according to an embodiment of the present invention.

FIG. 16D shows an example embodiment of a tag housing according to an embodiment of the present invention.

FIG. 16E shows an example embodiment of a tag housing according to an embodiment of the present invention.

FIG. 16F shows an example embodiment of a tag housing according to an embodiment of the present invention.

FIG. 16G shows an example embodiment of a tag housing according to an embodiment of the present invention.

FIG. 16H shows an example embodiment of a tag housing according to an embodiment of the present invention.

FIG. 16I shows an example embodiment of a tag housing according to an embodiment of the present invention.

FIG. 16J shows an example embodiment of a tag housing according to an embodiment of the present invention.

FIG. 16K shows an example embodiment of a tag housing according to an embodiment of the present invention.

FIG. 16L shows an example embodiment of a tag housing according to an embodiment of the present invention.

FIG. 16M shows an example embodiment of a tag housing according to an embodiment of the present invention.

FIG. 16N shows an example embodiment of a tag housing according to an embodiment of the present invention.

FIG. 16O shows an example embodiment of a tag housing according to an embodiment of the present invention.

FIG. 16P shows an example embodiment of a tag housing according to an embodiment of the present invention.

FIG. 17A shows an example embodiment of tag features according to an embodiment of the present invention.

FIG. 17B shows an example embodiment of tag features according to an embodiment of the present invention.

FIG. 17C shows an example embodiment of tag features according to an embodiment of the present invention.

FIG. 17D shows an example embodiment of tag features according to an embodiment of the present invention.

FIG. 17E shows an example embodiment of tag features according to an embodiment of the present invention.

FIG. 17F shows an example embodiment of tag features according to an embodiment of the present invention.

FIG. 17G shows an example embodiment of tag features according to an embodiment of the present invention.

FIG. 18 shows an example alert report according to an embodiment of the present invention.

FIG. 19 shows an example alert report according to an embodiment of the present invention.

FIG. 20 shows an example alert report according to an embodiment of the present invention.

FIG. 21 shows an example exception report according to an embodiment of the present invention.

FIG. 22 shows an example site performance report according to an embodiment of the present invention.

FIG. 23 shows an example organization performance overview report according to an embodiment of the present invention.

FIG. 24 shows an example graphical user interface embodiment according to the present invention.

FIG. 25 shows an example graphical user interface embodiment according to the present invention.

FIG. 26 shows an example graphical user interface embodiment according to the present invention.

FIG. 27 shows an example graphical user interface embodiment according to the present invention.

FIG. 28 shows an example graphical user interface embodiment according to the present invention.

FIG. 29 shows an example graphical user interface embodiment according to the present invention.

FIG. 30 shows an example graphical user interface embodiment according to the present invention.

FIG. 31 shows an example graphical user interface embodiment according to the present invention.

FIG. 32 shows an example graphical user interface embodiment according to the present invention.

FIG. 33 shows an example graphical user interface embodiment according to the present invention.

FIG. 34 shows an example graphical user interface embodiment according to the present invention.

FIG. 35 shows an example graphical user interface embodiment according to the present invention.

FIG. 36 shows an example graphical user interface embodiment according to the present invention.

FIG. 37 shows an example graphical user interface embodiment according to the present invention.

FIG. 38 shows an example graphical user interface embodiment according to the present invention.

FIG. 39 shows an example graphical user interface embodiment according to the present invention.

FIG. 40 shows an example graphical user interface embodiment according to the present invention.

FIG. 41 shows an example graphical user interface embodiment according to the present invention.

FIG. 42 shows an example graphical user interface embodiment according to the present invention.

FIG. 43 shows an example graphical user interface embodiment according to the present invention.

FIG. 44 shows an example graphical user interface embodiment according to the present invention.

FIG. 45 shows an example graphical user interface embodiment according to the present invention.

FIG. 46 shows an example graphical user interface embodiment according to the present invention.

FIG. 47 shows an example graphical user interface embodiment according to the present invention.

FIG. 48 shows an example graphical user interface embodiment according to the present invention.

FIG. 49 shows an example graphical user interface embodiment according to the present invention.

FIG. 50 shows an example graphical user interface embodiment according to the present invention.

FIG. 51 shows an example graphical user interface embodiment according to the present invention.

FIG. 52 shows an example graphical user interface embodiment according to the present invention.

FIG. 53 shows an example graphical user interface embodiment according to the present invention.

FIG. 54 shows an example graphical user interface embodiment according to the present invention.

FIG. 55 shows an example graphical user interface embodiment according to the present invention.

FIG. 56 shows an example graphical user interface embodiment according to the present invention.

FIG. 57 shows an example graphical user interface embodiment according to the present invention.

FIG. 58 shows an example graphical user interface embodiment according to the present invention.

FIG. 59 shows an example graphical user interface embodiment according to the present invention.

FIG. 60 shows an example graphical user interface embodiment according to the present invention.

### DETAILED DESCRIPTION

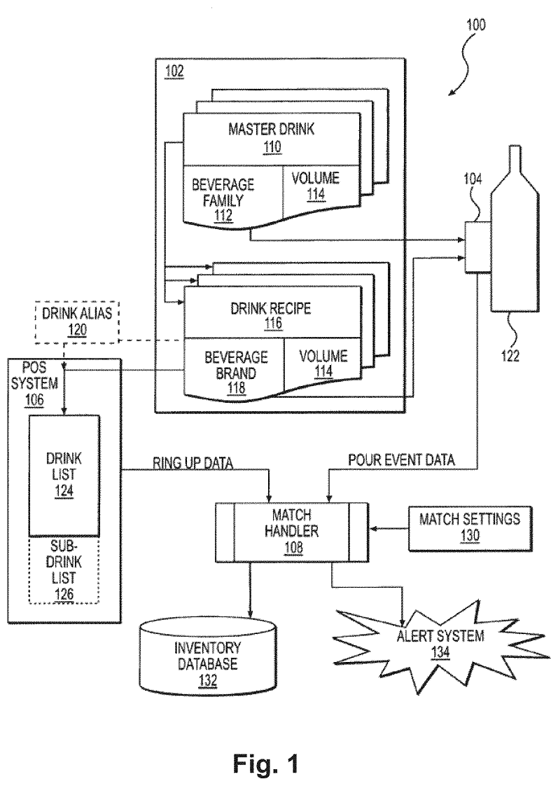

FIG. 1 shows an example embodiment of a beverage pour system.

In embodiments of the present invention, various options for taking inventory are provided. In addition to the options provided herein, inventory can also be taken manually by a user of the system. For example, a user can scan the bottle tag QR code with the mobile device or scanner, the system then inputs the exact type and brand of bottle. The user can then with a finger through a touch interface, increase or decrease the fluid level on the GUI to match the physical level of the bottle associated with the bottle tag. The increasing and decreasing of the fluid level can be done by various ways including: moving a level of color in a digital image of the bottle via the GUI; sliding a feature up and down along or in the digital image of the bottle to indicate the height; press a button(s) or soft button(s) to increase or decrease the volume level in a digital image of the bottle or just a numerical indicator of the volume; move a circular interface indicator to increase or decrease the viewable volume level in a digital image of the bottle. The system then can take that measurement, knowing already inputted bottle measurements for that specific brand and type and bottle volume, and calculate the volume of the fluid inside using standard geometry. Alternatively, the user can type or input the perceived level or height of fluid via the GUI, and the system will then calculate the volume of the fluid inside using standard geometry.

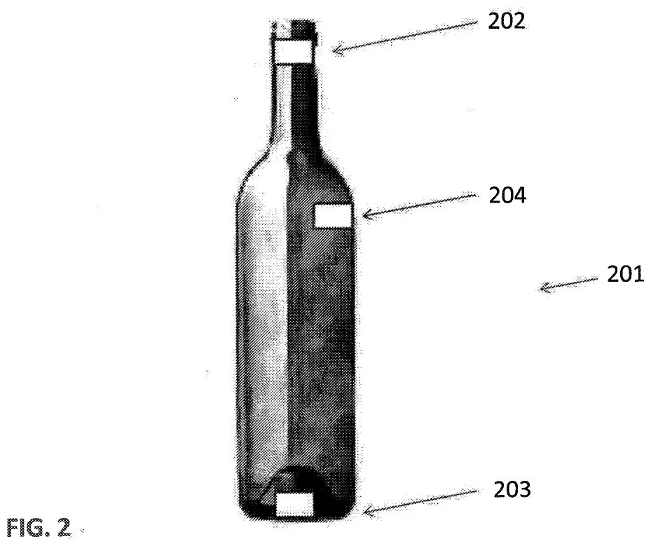

FIG. 2 shows an example embodiment of a tag according the present invention. In an embodiment, the tag is a sensor attached to a specific location on a bottle or other liquid container 201. For example, the tag 202 can be located at or near the tip or lip 202 of the bottle 201. For example, the tag 203 can be located at the bottom of the bottle 201. Or, for example, a tag 204 can be located at another location of the bottle 201. In an embodiment, there can be multiple tags or sensors located on a bottle or liquid container 201. The tag can be mounted or disposed on the bottle using an adhesive, attachment means, snaps, magnet, hook and loop, mounted brackets allowing the tag to be removeable, and other available methods for attaching a device to a bottle or container.

In order to determine the meaning of certain tilt angles, the system also tracks the location of the specific sensor or tag. In an embodiment, the tag measures the tilt and the time in each tilt zone. In an embodiment, a software system receives the tag tilt and time data. In an embodiment, the software system can be controlled and/or maintained on a desktop, mobile device, or via a remotely-accessible server. In an embodiment, the angle of the tag is periodically measured. In an embodiment, the tag is portable and communicates with a software system or control system via Bluetooth® or other data transmission method. In an embodiment, the tag sends the data as a broadcast but can also send data in a two-way transmission with a handshake. The measured values are transmitted periodically in an embodiment. In an embodiment, the tag transmits operating counters, battery voltage, and other operating features. In an embodiment, the tag sends a periodic “alive” or system status signal in order to show present functioning capabilities. In an embodiment, the tag stores the measured data, and uploads the data at periodic time events.

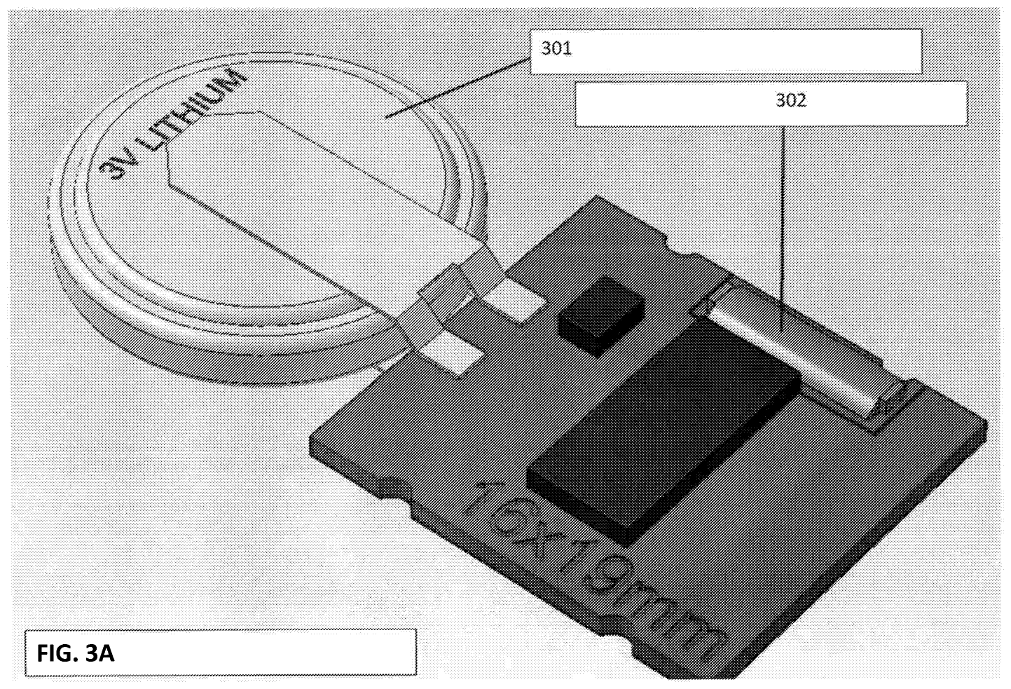

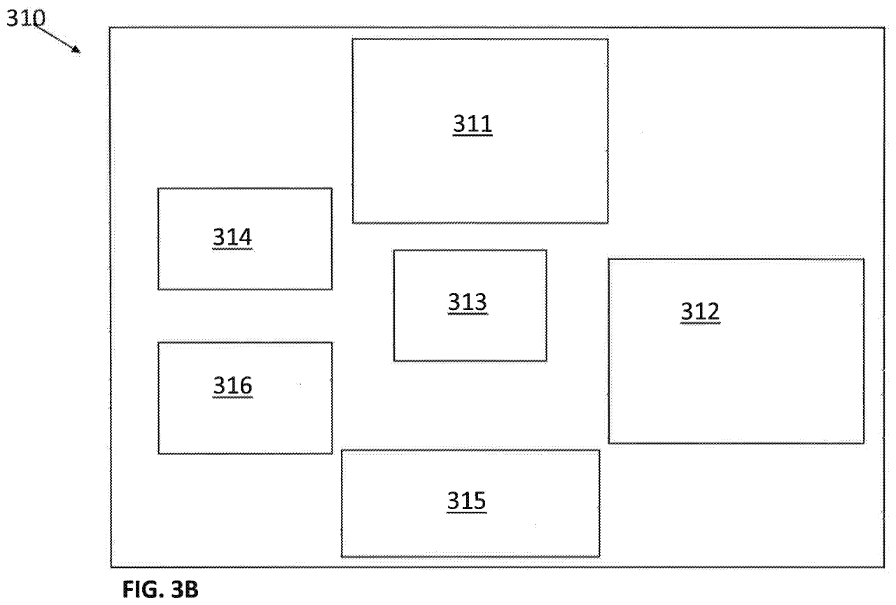

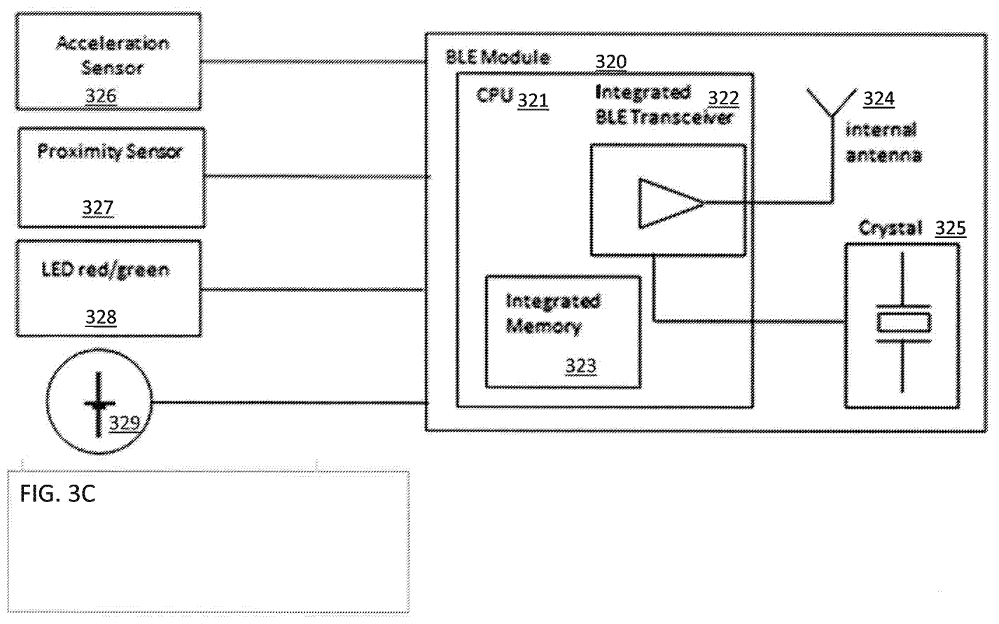

FIG. 3A shows an example embodiment of a tag of the present invention. In FIG. 3A, a tag is shown having a battery 301, such as a 3 volt lithium battery, which can be attached to the circuit via a stiff or immobile attachment conducting piece or soldered to the circuit or via a moveable attachment conducting piece. The circuit which is powered by the battery includes a movement an acceleration chip 302. A movement and acceleration chip recognizes when the tag moves or is moved. This movement of the movement and acceleration chip on the tag triggers a wake up of the central processing unit (CPU) to initiate taking of one or more measurements. The measurements can be a calculation or measurement allowing for calculation of an angle during the pour measurement. The pour measurement can also include a measurement of time at specific angles or tilts. The circuit can include an infrared proximity sensor. The infrared proximity sensor is used to determine when attached to a bottle. The circuit can include storage device for storing production data. The circuit can include a reader and transmission device, such as a chip having an integrated CPU and antenna.

FIG. 3B shows an example embodiment of a tag of the present invention. In FIG. 3B, a tag 310 is shown having various components: Bluetooth® chip with an integrated CPU and antenna 311; non-volatile memory device 312 such as an electrically erasable programmable read-only memory (EEPROM), for storing production data such as a serial number; dual green-red light emitting diode (LED) 313 or infrared (IR) LED or other indicator; infrared proximity sensor 314 to recognize when attached to a bottle; movement and acceleration chip 315; and a polarization protection circuit 316 to protect against when a user inserts the battery powering the circuit incorrectly, so that the tag's components are not damaged. The movement and acceleration chip 315 recognizes when the tag (including this chip) moves and wakes up or triggers the CPU to recognize and/or register via the tag a start of measurement and subsequent calculation of the measurements. Embodiments of the present invention do not need to include all of these features shows in FIG. 3B, such as the polarization protection circuit 316.

In FIG. 3B, the dual or infrared LED is used because one may not be able to see normal LED outside the tag housing. One could see IR signaling through the housing if the tag housing is IR transparent. In an embodiment, the tag housing is comprising of an IR transparent material, e.g., a plastic material such as that manufactured under Makrolon. In an embodiment, the signaling—whether IR LED or dual green-red LED or another—is viewable by an observer and/or a mobile device.

In an embodiment of the present invention, a calibration is made when the tag is associated with a bottle or object. For simplicity here, the object referred to will be a bottle containing fluid. The tag can be placed in a variety of positions on a bottle, and the tag could be placed at an angle or even upside down on the bottle by a user. Accordingly, a calibration is made in order to determine the exact angle of the tag circuit (tag) on the bottle. That exact angle measured is then calibrated by the system as the 0 degree or vertical position of the bottle. That calibration occurs every time the bottle has been stationary for a threshold amount of time, e.g., 5 seconds. This is because a user may move the tag on the bottle when using the bottle, or some other event could occur to change the placement of the tag after a first calibration.

In an embodiment of the present invention, there are two steps of calibration that occur. First, a basic calibration is made to determine, e.g., whether the tag is face up or downwards on the bottle. With this information alone, the system can then measure and calculate pours from the bottle. The error measurement of such has been calculated to be roughly 5 to 10% error. Thus, a bartender or user can put the tag in the tag housing onto a bottle, and after 5 seconds (or other preset threshold of time) of the bottle being stationary, upright, the bartender can do a pour that is measurable within this low error rate. For this calibration, a user can hold the bottle upright—the bottle does not need to be stationary/still on a table or flat surface. After the tag is attached and basic calibration has occurred, then the bottle can be placed on a table or other surface allowing for stationary or no movement of the bottle. Upon a passing of a time threshold, e.g., 5 seconds, the system can effect a precise calibration of the tag on the bottle. Once that precise calibration has occurred, the subsequent pour measurements are precise as well.

In a system embodiment, a basic calibration includes the steps of: having the bottle with the tag remain in an upright or roughly upright orientation (e.g., pitch between 0 and 20 degrees deviant from the vertical position) for a specific time threshold (e.g., 5 seconds); then the system sets that measurement to a zero angle with a plus or minus 90 degrees if the tag is upright or upside down on the bottle; then the measurement error is set in the system for between 5 to 10%. This error is basically the angle of the tag itself on the bottle since the tag is not always placed perfectly parallel to the bottle neck.

In a system embodiment, a precise calibration includes the steps of: having the bottle with the tag remain completely still for a specific time threshold, e.g., 5 seconds; check the currentpitch measurement between 0 and 20 degrees deviance from the vertical position if there is no change in measurement or if basic calibration has been done; check the currentpitch measurement if between 0 and 20 degrees deviance from the vertical position and the currentposition measurement has change for more than 1 degree from a previously recorded precise calibration; set the currentposition measurement to zero angle. In this calibration, the error measurement is typically less than 5%. This provides for a very good measurement of pours from the bottle, allowing for a more precise calculation of the bottle volume and other calculated information from the measurement data recorded by the system via the tag.

In an embodiment, the determination of the white/clear/black/dark bottle can be based on reflection or another known means. For example, an IR proximity sensor is used to detect whether the tag is attached to a bottle. The tag housing, see embodiments described herein, is completely IR transparent, and so the tag housing does not interfere with the detection of the bottle. When the tag is placed on a bottle, the system detects a reflection based on the material and color of the bottle. In an embodiment, each IR proximity sensor of each tag is calibrated at production so that the system knows the value when there is no reflection. Dark bottles such as black colored bottles provide the smallest reflection grade, which makes it difficult to detect. Accordingly, the system determines a threshold grade so that in order to detect that the tag is attached or associated with a bottle, then the IR proximity sensor must detect a reflection grade above that threshold grade in the system. In an embodiment, a user can check the system and update the system should a tag be found to be attached to a bottle such as a dark bottle which did not register as having the threshold reflection grade.

In an embodiment, the tag measures and transmits on request the exact movements as a current angle per time unit. This allows a business to see how the bartender did a pour event and can display the angle in a graph for each tens of a second, for example.

In an embodiment, the tag is always in a powered-down mode where it uses a very minimal amount of power, e.g., 5 microAmps. The movement and acceleration sensor is what is using that minimal amount of power during the powered-down mode, and can be active a specific amount of time, e.g., one measurement per second. Once there is movement detected by the sensor, then the sensor “wakes up” or triggers power-up by the CPU. The CPU will then switch the movement and acceleration sensor to a faster measuring speed (e.g., 10 measurements per second) and will scan if there is a tilt of the tag (i.e., bottle that the tag is on) of more than 62.04 degrees or other set amount. Then the system will start measuring the pour event. Once the tag is measured by the system to be less than 62.04 degrees or other set amount tilt, then the pour event is considered finished and the tag sends the measurement data from that pour event via Bluetooth® to the reader device. The CPU of the tag then switches the tag to powered-down mode again. The CPU will “wake up” or power up every other minute (or other set amount) to repeat the transmission of the last pour event or multiple last pour events. This can ensure that the system receives at least one if not multiple copies of the same data, allowing for redundancy which is later determined rather than losing data. In an embodiment, this transmission is by broadcast.

In an embodiment, the tag measures tilt, time, and other details. The tag can also measure the temperature and such data is sent to the server. This temperature information is used by the server application to monitor the temperature of the cooling devices and/or of the quality of the storage situation. The system can track specific threshold temperature changes, since large variations in temperature can harm the quality or viability of certain fluids.

In an embodiment, a tag communicates by sending and receiving data, as described herein. This can allow for the system to conduct firmware updates from the Master app or central server or providing company server. In an embodiment, this can allow for sending marketing information to the tags. The tags can then display this information on its display screen—as shown in the figures—or transmit that information to the company's server for further dissemination. The display on the tag could be promotion price, advertising, ingredients or other health information, customer branding, or other information desired by the client or user of the system.

In an embodiment, the tags have a small LED light to signal that it is attached or detached, etc. The bar owner or user of the system can use the LED light or an additional LED light controlled by the tag or the system or the app to make a blinking light or colored light for certain promotional or marketing information dissemination. For example, if a customer buys two drinks from the red blinking LED bottle, then the customer gets a discount or gets entered into a raffle or other promotional effort.

In an embodiment, the tag has a small camera or reader which the user can trigger via the mobile app or the system or an external button or soft button on a display screen on the tag. For example, upon a trigger of the camera or scanning module, the system automatically enters the type of bottle and liquid into the inventory system associated with that tag identification. In this case, there is no need for an external scanner by the user.

FIG. 3C shows an example tag. Some features of this tag can differ, depending upon the desired result and different technical chips employed (e.g., some integrated chips might include other functionalities). In FIG. 3C, the tag includes a Bluetooth® low energy (BLE) module 320, having a CPU 321 with an integrated BLE transceiver 322 and an integrated memory 323 for storing data, an internal antenna 324 and a crystal 325. The module can be connected or associated with an acceleration sensor 326, a proximity sensor 327, and dual red/green LED 328, and a power source 329 or battery.

In an embodiment, the tag firmware is loaded during production process and initialized with a unique identified (ID). The production process and behavior of the tag is defined with the operations team. The tag ships to a customer or location or is stored at location in STORAGE mode, meaning that no message is transmitted during this mode. In order to get the tag out of the STORAGE mode, the tag is presented with a strong light source (e.g., flashlight), and then the proximity sensor send this information to wake up the CPU. The tag LED blinks to signal this event.

In an embodiment, when fixing the tag on a bottle, the proximity sensor then detects the bottle's existence, and the tag sends an INVENTORY ATTACH message 3 times within 3 seconds (With the value of “Minutes Since Last Attach”=0) or other preset amount. The tag stays in INVENTORY ATTACH mode as long as the proximity sensor still detects a bottle. This message is sent cyclically every 6 minutes.

In an embodiment, by detecting a tilt event (e.g., angle over approximately 60° from absolute 0° or other preset angle amount), the tag starts measuring pouring time and tilt angle per time. Once the bottle is back in an upright position, the tag recognizes the end of pour and sends a burst of 3 POUR messages within 3 seconds (or other amount), including the pouring duration times for every angle sector and the pour counter to the system.

In an embodiment, the tag measures a duration of 25.6 seconds in every angle sector (12 sectors). If the bottle is detected as staying in one of the sectors for more than 25.6 seconds, the POUR message will have the Value 256 (preset maximum) in that field, and the tag will then stop measuring.

In an embodiment, when the tag is removed from the bottle, the tag sends a burst consisting of 3 INVENTORY DETACHED messages within 3 seconds (With the value of “Minutes Since Last Detach”=0) or other preset amount, and then the tag stays in INVENTORY DETACH mode until the tag is placed again on a bottle or the tag is set to STORAGE mode. In an embodiment, the INVENTORY ATTACH or DETACH message includes the measurements of the last pours. In this message, the pour duration times of the last “n” pours are summed up in every angle sector. The number of “n” pours transmitted is limited by the total time of 25.6 seconds in each angle sector. This is basically a log file of the last pours.

In an embodiment, the tag sends the INVENTORY DETACHED message every 12 Minutes until the Tag is placed again on a bottle or the tag is set to STORAGE mode or a set threshold of time (e.g., 4 hours) has passed. This time is configurable. In an embodiment, the tag sends an ALIVE message every 12 minutes if the tag is functional and attached to a bottle.

For shipping, transportation and longterm storage, the tag can be set to STORAGE mode. The STORAGE mode is activated by a special sequence or BLE command or by a special sequence preset by the user or the administrator such as a pour is started, 4 seconds pass, the tag is detached from the bottle while the bottle is measured to be in horizontal position.

In an embodiment, the tag can be configured and the firmware can be changed after production process. For example, the tag can be set to automatically auto correct to 0° when attached to the bottle (even if attached at an incorrect angle) or be set to send a correction value.

In an embodiment of the present invention, the reader is located in the tag itself, and transmits from the tag hardware via universal asynchronous receiver transmitter (UART) to a Raspberry Pi or other receiving type of device. UART communication protocol is known. In an embodiment, the reader and the Raspberry Pi just receive data and then forwards the data to the server(s). In an embodiment, a timestamp is added to the data forwarded. In an embodiment, a timestamp and other information is added to the data forwarded. In an embodiment, there are two ways of communication between the tag hardware (including the reader) and the Raspberry Pi (or other receiving device): i) normal broadcast mode; and ii) connected mode. Normal broadcast mode is when the tag sends our data such as pour events via broadcast, without any handshake from the reader. Such broadcast is, e.g., BLE communication protocol. Connected mode is when the reader pairs with a tag and gets into a connected mode where a user can read/write additional data into the tag. For example, Bluetooth® commands are used in the connected mode.

The Raspberry Pi (or receiver—for purposes here, this is referred to as the Raspberry Pi but could be a different receiving device) connects to the reader and opens communications and listens. In the connected mode, described above, the tag can be updated.

In an embodiment, when a message is received from a tag, and one or more Raspberry Pis can received it at the same time or different times, a timestamp is added and then (optionally) held in buffer, and then sent as a raw message and timestamp. It is held in a buffer if the system is offline or just needs to be queued up and transmitted. Other information in addition or in place of a timestamp can be appended such as signal strength, device identification, et al., to the server. The transmission is asynchronous. In an alternate embodiment, the transmission is synchronous. In an alternate embodiment, the transmission is synchronous and the message is acknowledged back to the Raspberry Pi.

In an embodiment, the Raspberry Pi is configured to only talk to the cloud site for the specific geographical location, e.g., bar, hotel. Each location is an independent application or site in the system. This means, for 300 locations for a single hotel, there are 300 apps and 300 databases. This separation of apps and databases by location allows for better security and integrity of the data and calculations. In such case, no data can “escape” into another location's system. In an alternate embodiment, the apps and databases are not separated and instead a part of the same or set of same resources.

In an embodiment, data integrity and calculations integrity is protected. One way is via an audit system in the present invention. For example, every table in the system (which allows a user to make a change) has a corresponding Audit table. For example, the Tag table has a Tag_Audit table. The Tag table stores the current record value, and the corresponding audit table has a copy of every record. A structured query language (SQL) trigger is used on insert or update on the main (e.g., Tag) table to copy that record to the Audit (e.g., Tag_Audit) table. Each is timestamped so that it is clear what changes were made and when. The system also stores in every table the lastmodified timestamp (as this can work offline this is when it was modified on the client), the last modified by (the user) and the ServerLastModified (this is the timestamp when the server saved it into the SQL DB).

For security purposes, all data is encrypted in transit. In an embodiment, one can use https-ssl 2048 bit certificates. In an embodiment, all data is stored on the server in SQL or in Azure Storage (for files, documents etc.) and all data at rest is encrypted in these systems.

In an embodiment, only certain entities, e.g., Azure app services or another company's services, is allowed access to the SQL server for each location. In an embodiment, no user is allowed a user name and password in SQL to be able to bypass the app. In an embodiment, a company is provided an administrative user name and password to bypass the app or security measures.

In an embodiment, there is a Master app which is where all customer sites are configured and there exists a master list of UPCs and images. This is where we configure the sites and have a master list of the universal product codes (UPCs) and images. This allows for when a new site is built or when an update to a UPC comes in, the providing company has one central place to manage and update the individual locations associated with that update or site. This can also allow for when a user logs in on the mobile app, the providing company can look up the site for that user's location and from then on they are talking to the user via the user's company site.

In an embodiment of the system, each location site has at least two readers and each of the readers can receive messages from the tags. The readers do not communicate with each other. In an embodiment, each reader is connected to the cloud server for that site via the Internet. When online, the reader receives the message and forwards it (with the other data mentioned herein) to the cloud server for its configured site.

In an embodiment, when the data is received by the cloud server, the cloud server puts the data into a FIFO (first in, first out) queue. This is because the data is being received in parallel, and multiple copies of the message may have been received. The system only wants to process a message once—even though the tag will have repeated the message multiple times in a few seconds, and each Raspberry Pi (or receiver) will have received and transmitted that same message onto the server. The server then processes all messages in the queue one at a time. The system on the server first checks if the system has received and processed the message, and if not, the raw message is saved to the database (and kept there for a set amount of time, e.g., 30 days). Once the raw message is saved on the database, then the message is processed by the system.

If the message received is an attached message (each tag sends this every 6 minutes (or other preset amount) to let the system know the tag is still there and attached), then the system decodes the information (e.g., this all is sent in plain text/byte array by the tag, or can be sent as an encrypted message from the tag to the reader/Raspberry Pi) according to the communication protocol and store that information in various places (e.g., in the tag record).

If the message received is a detached message (each tag sends this every 12 minutes (or other present amount) to let system know it is still there and also when detached), then the system decodes the information. This information can be stored in the tag. The system also checks the current tag attachment (the bottle/UPC the tag is attached to). If there is less than 10% fluid calculated as remaining in the bottle, the system automatically detaches the tag from the bottle and marks the bottle record as empty. In an embodiment, the system adjusts the inventory in the bar or location by the amount remaining. If the fluids amount is greater than 10% but less than 20%, then the system sends a warning notification to the bar or location via the app or message or email or other communication means. If greater than 20% the system sends an alert to the bar or location via the app or message or email or other communication means.

If the message is a calibration message (each tag calibrates 5 seconds (or other preset amount) after the tag is attached and kept level or 5 seconds (or other preset amount) after the last pour), then the system stores this information in the tag. Information can be battery level, temperature, calibration angles and thresholds, etc.

If the message is a pour message, then we first check if the system has already processed this pour (the tag sends the pour message repeatedly on a frequent basis for approximately 20 minutes (or other preset amount) in case the system missed it. This is not a repeat of the raw message, but of the pour message—it will have the same pour data but other data which is different). If the system has not processed the pour message, then the system checks that the pour message is attached to the tag in the software and that it is physically attached (in the message data). The system then gets the tag, the UPC, and the formula, and calculates the volume poured. The system saves the pour information. Then the system updates the inventory for the UPC in the bar or location. In an embodiment, the system also update the remaining volume for this tag.

The system then does a check on the par levels for this UPC and inventory amount, based on lead time to order, bottles/per day used and par level. The system alerts if this is now going to be below par and needs reordering.

In an embodiment, at all times, whenever information is received and records (tag, pours, attachments, inventory etc.) are updated as soon as they are saved in the database, the system also automatically pushes a live update to all applicable client systems and the client systems update all screens that are displaying that data.

In an embodiment, the system reorders based on inventory, such that the system automatically creates orders, exports orders to excel and receives orders. In an embodiment, there are dashboards, viewable herein in the various figures provided, for various data including by timestamps and other grouping features (inventory/pours/etc.). These dashboards can be updated dynamically by the system, and printed to pdf or other type doc. In an embodiment, the system allows for a user to override the inventory system and adjust as needed using the mobile app, by scanning tags, using a touch interface to indicate volume levels, etc. In an embodiment, the Raspberry pi or receiver includes a touch screen version which allows a user to attach tags to bottles, move bottles from inventory to empty to other locations, receive orders, and other functions.

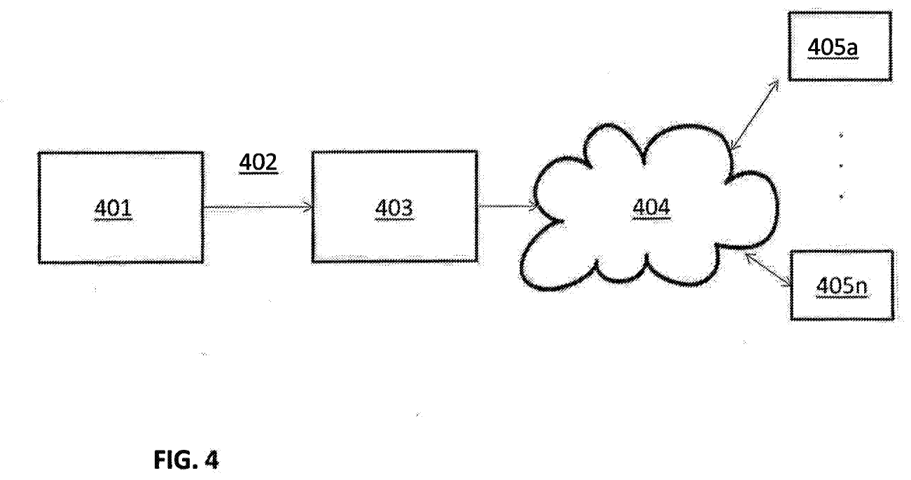

FIG. 4 shows an example system according to the present invention 400. For example, data 402 is transmitted from a pour system or liquid monitoring system 401 (e.g., such as that shown in FIG. 1) to local or remote receiver and/or processing device(s) 403. In an embodiment, the data 402 is transmitted to a local or remote device, e.g., a desktop computer, a laptop computer, a mobile device, an iPAD, an Apple Watch, or a mobile telephone. In an embodiment, the data 402 is transmitted to a local receiving device, which then transmits the data to a processing device. In an embodiment, the data 402 is transmitted to a remote receiver or processor or server. In an embodiment, the data 402 is transmitted from the local or remote receiver and/or processing device(s) 403 to the Cloud or network 404. From the Cloud, for example, various entities 405a to 405n can access the data, reports, analyzed data, and other information made available to them.

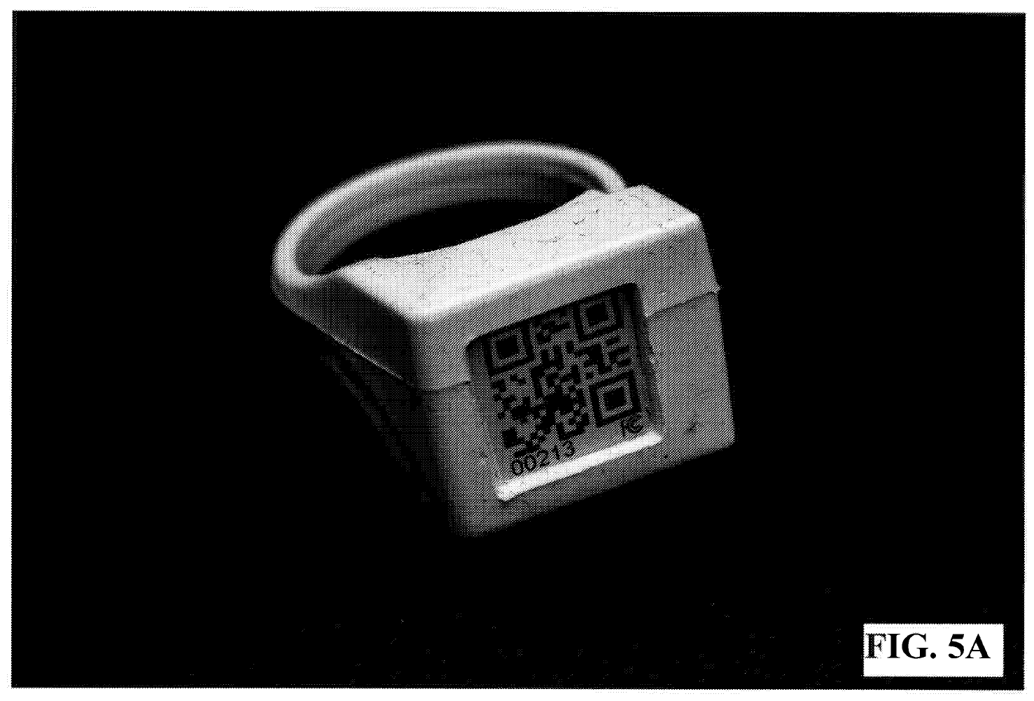

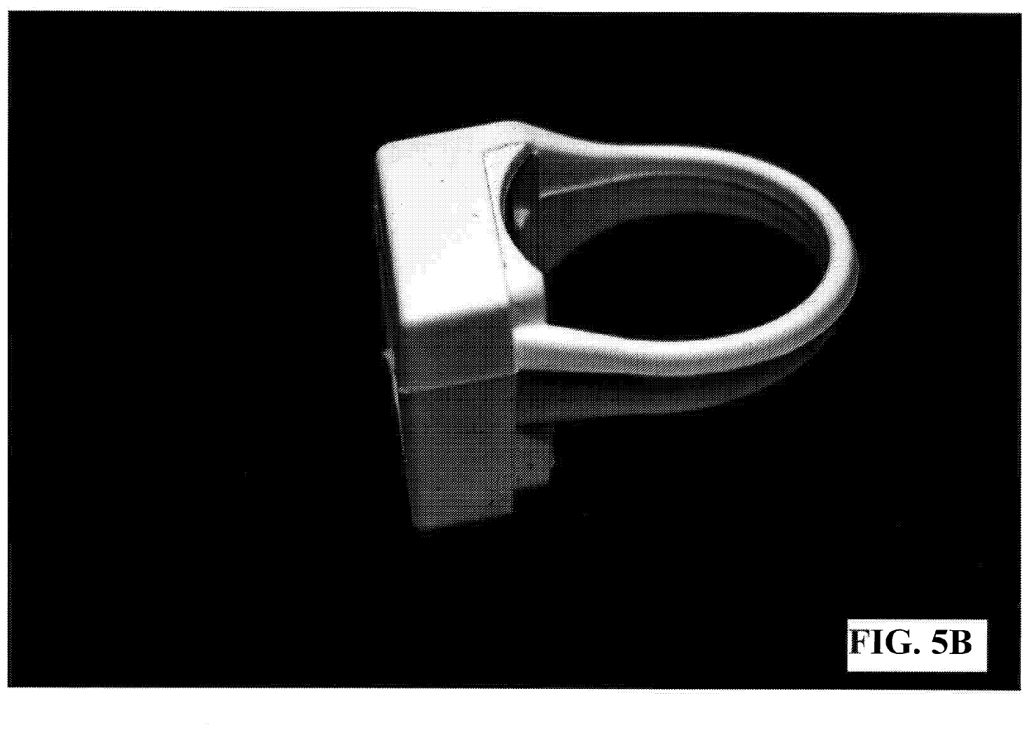

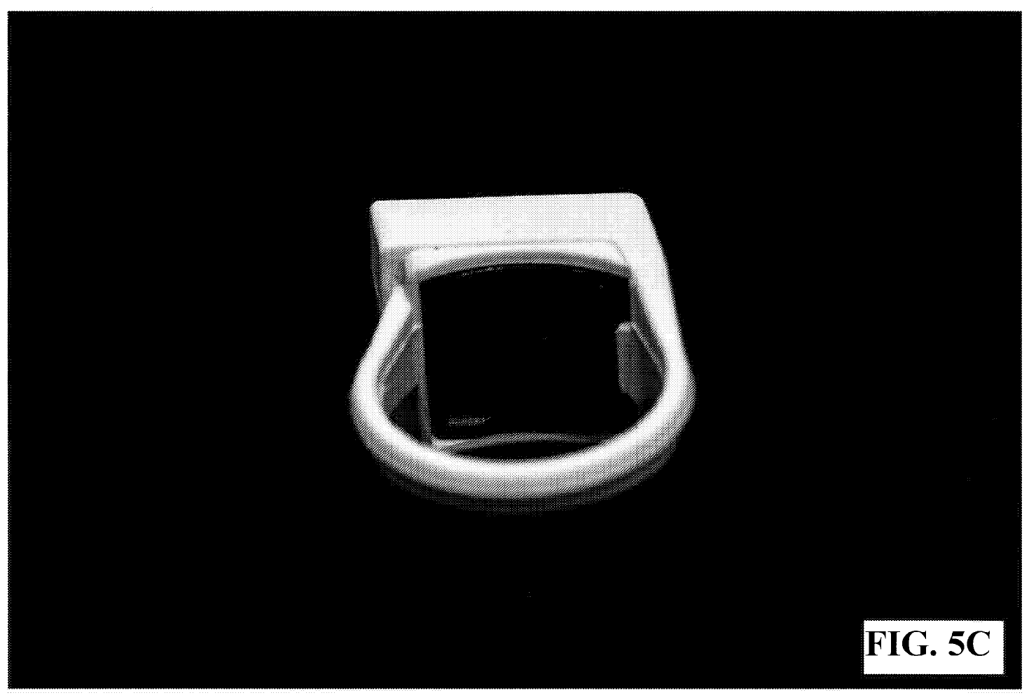

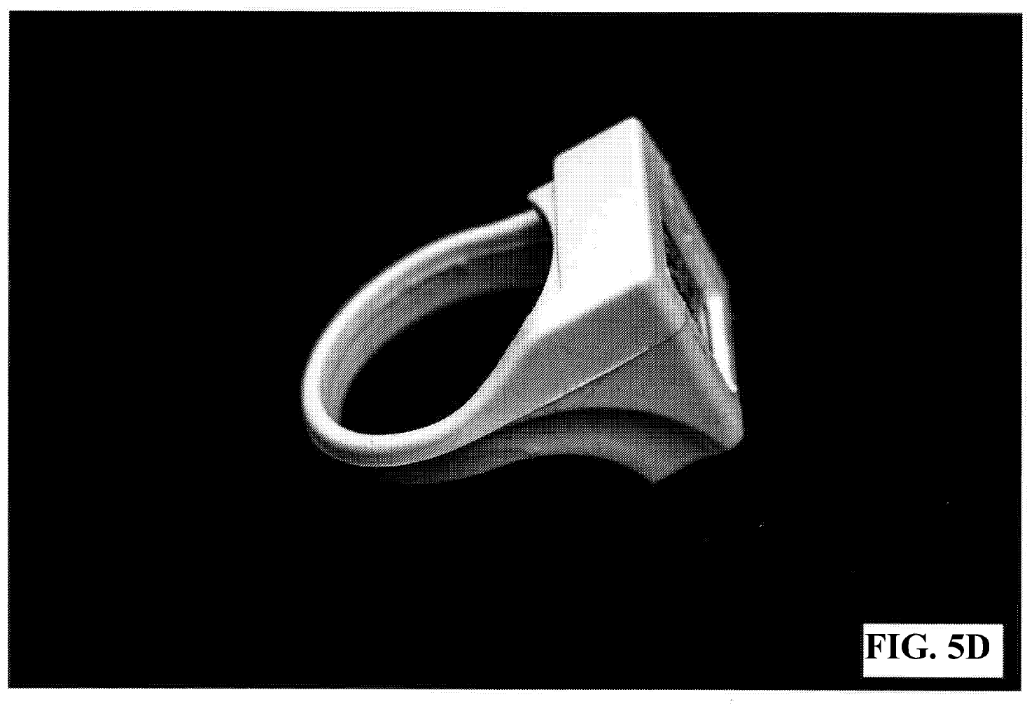

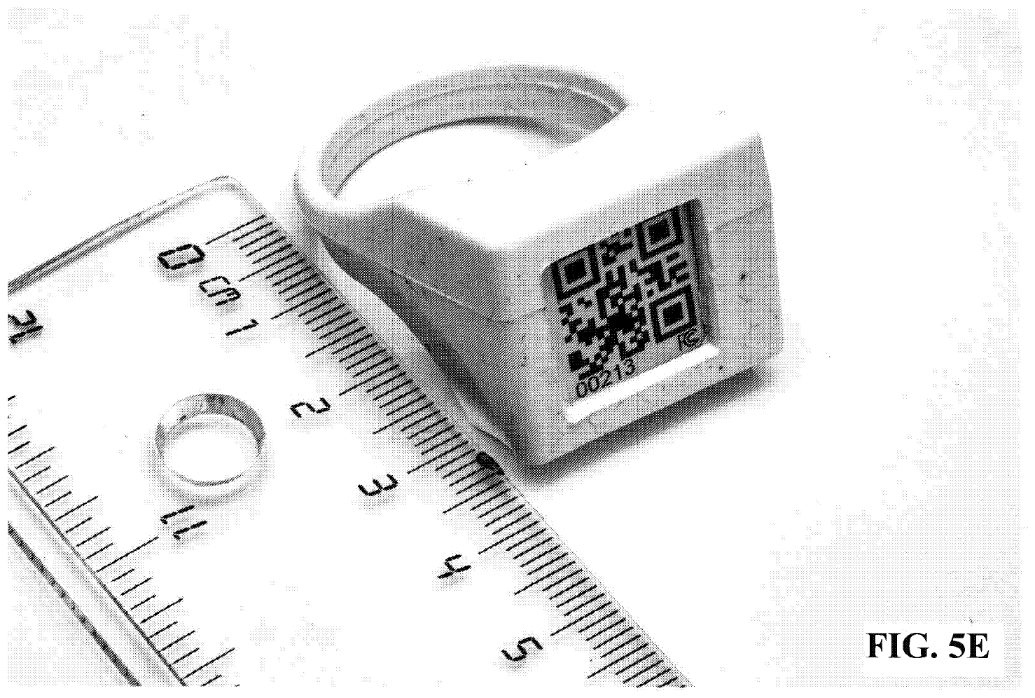

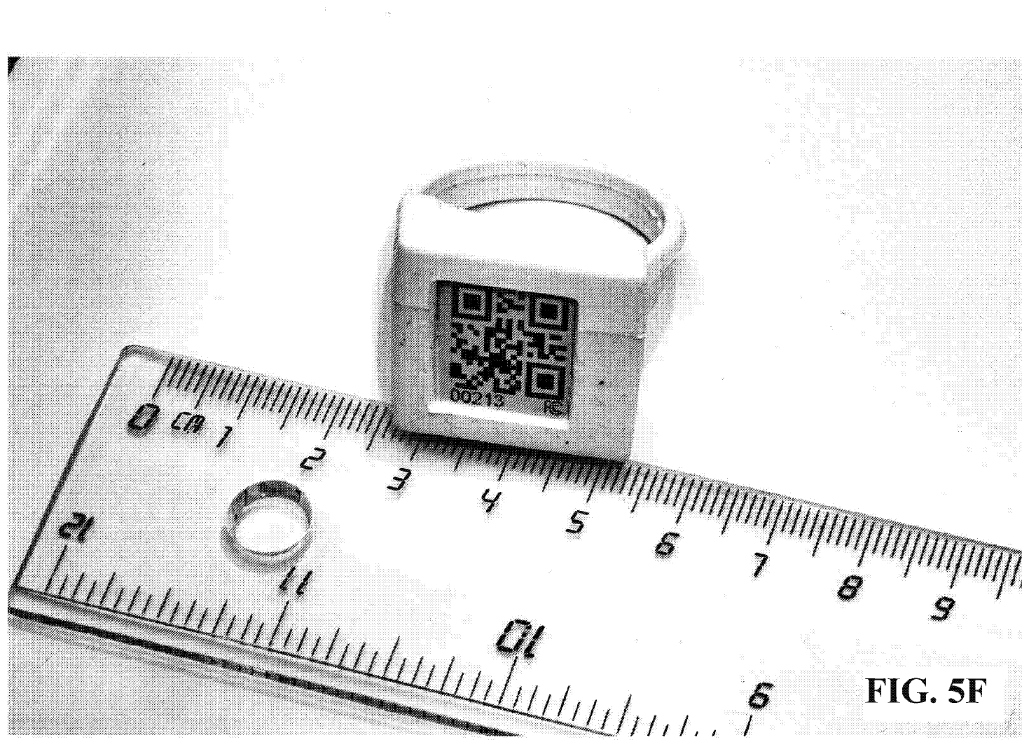

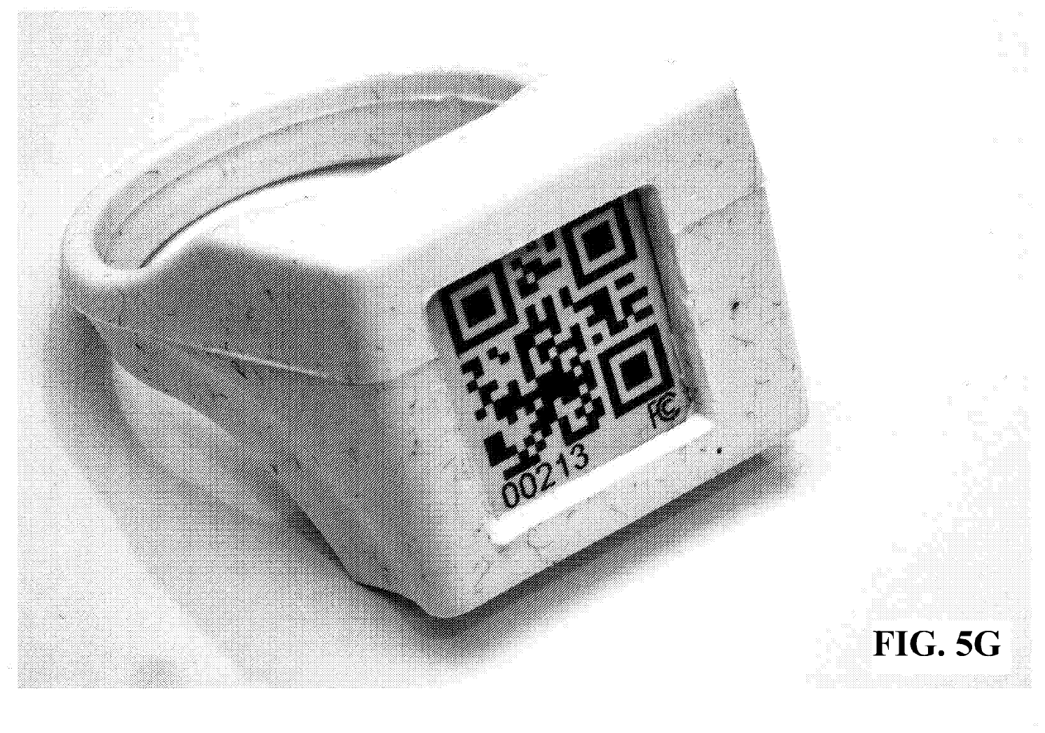

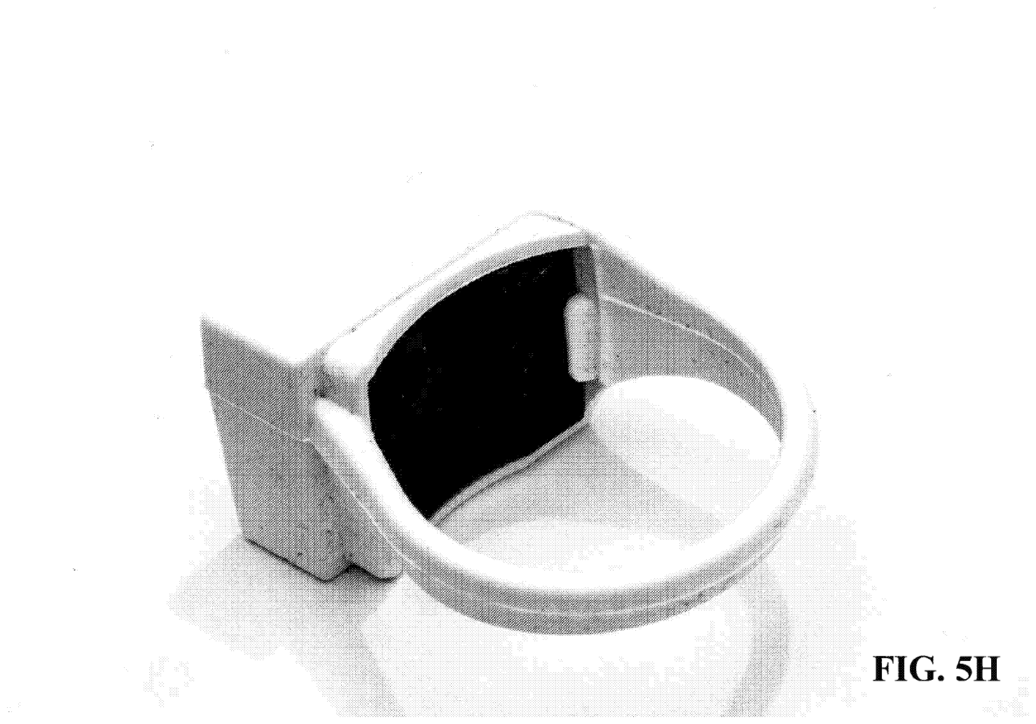

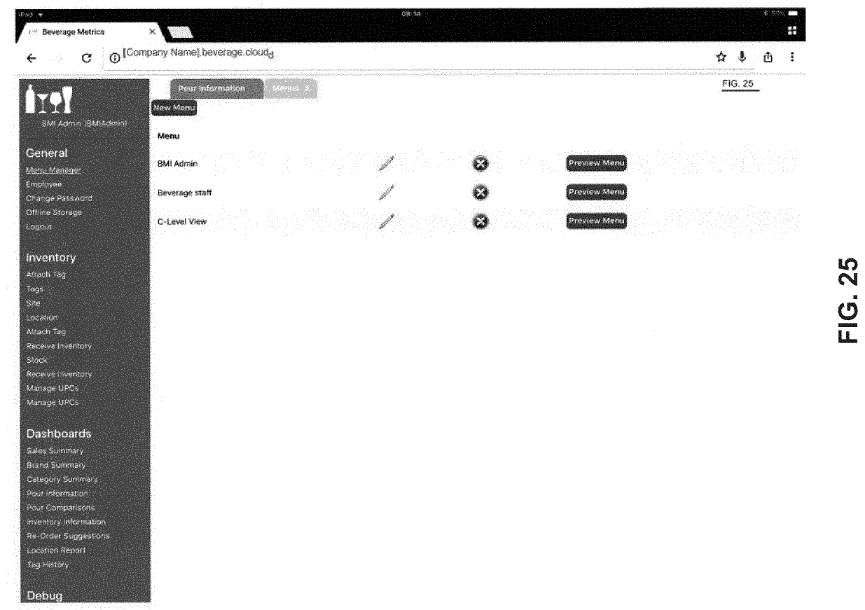

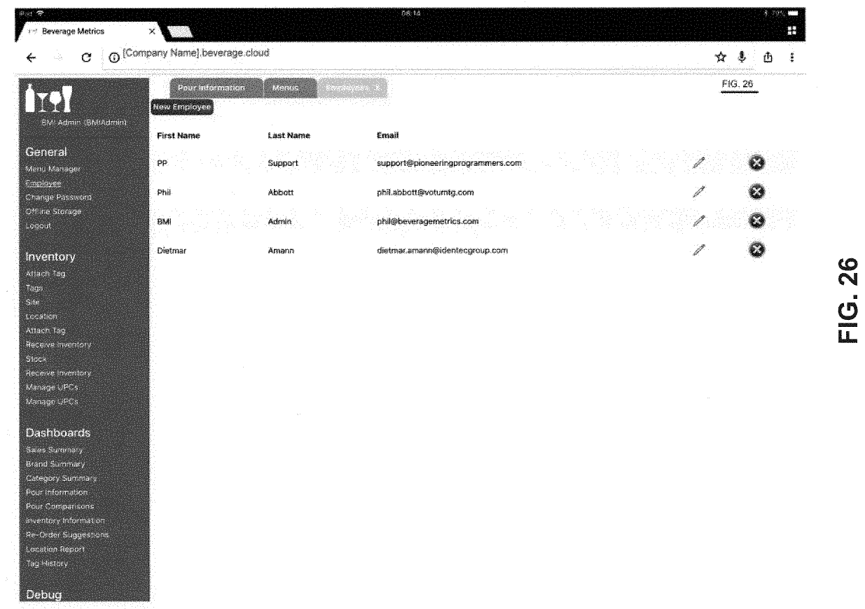

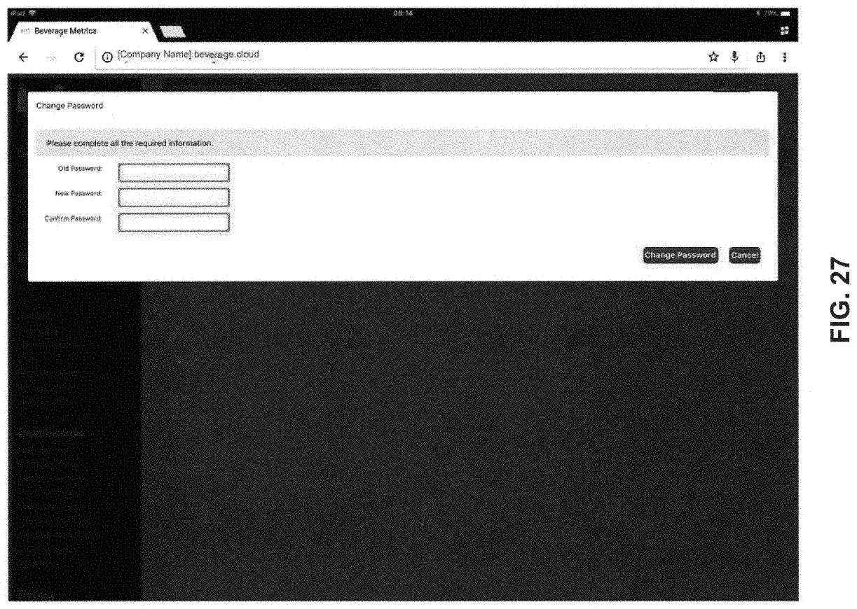

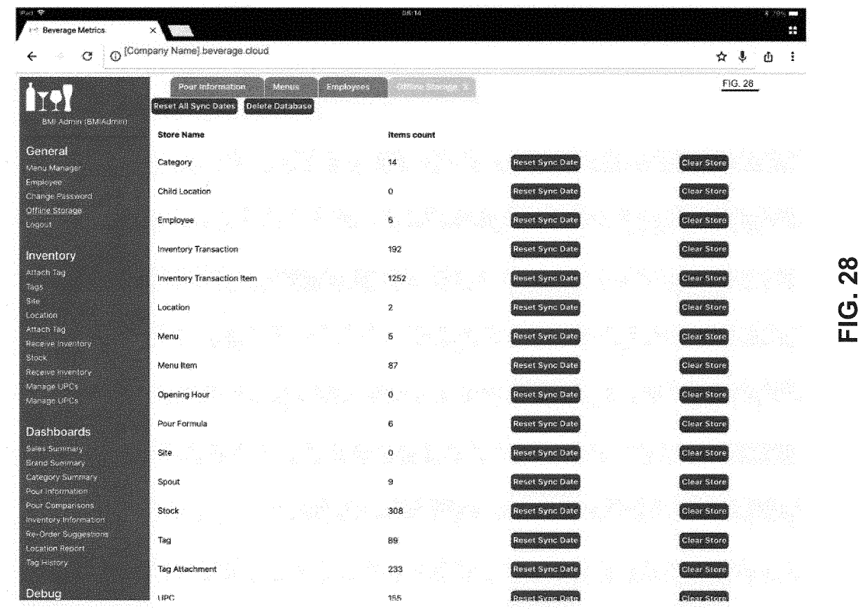

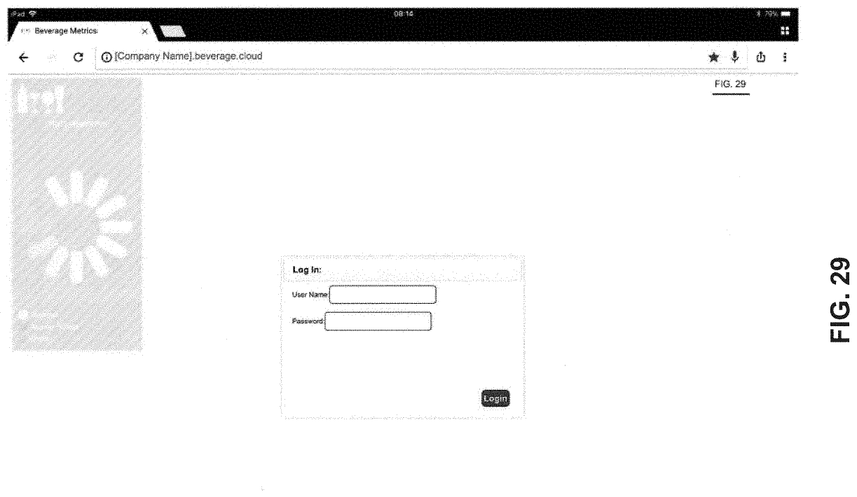

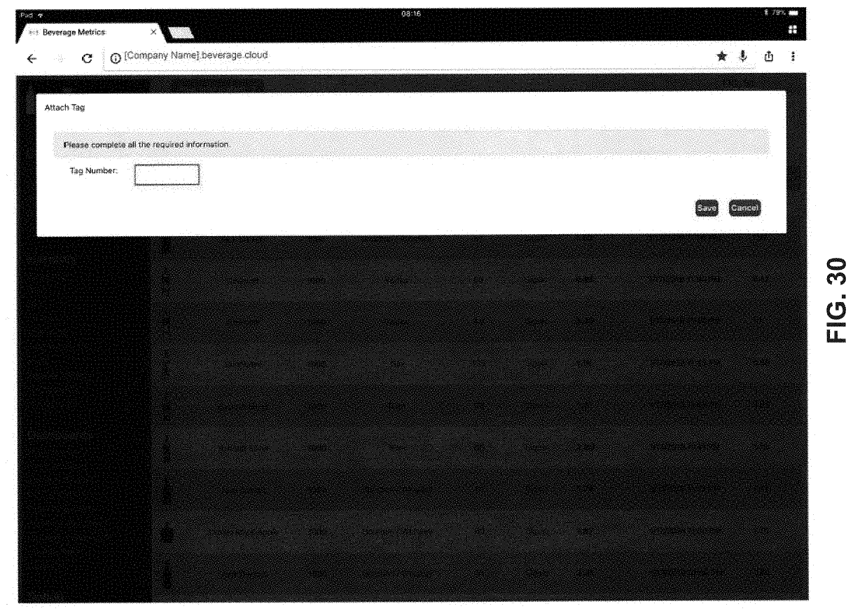

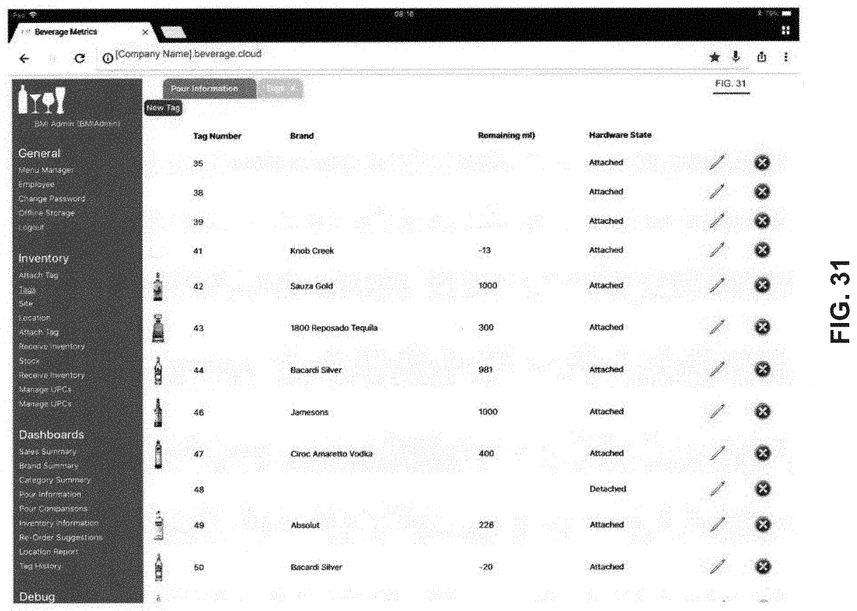

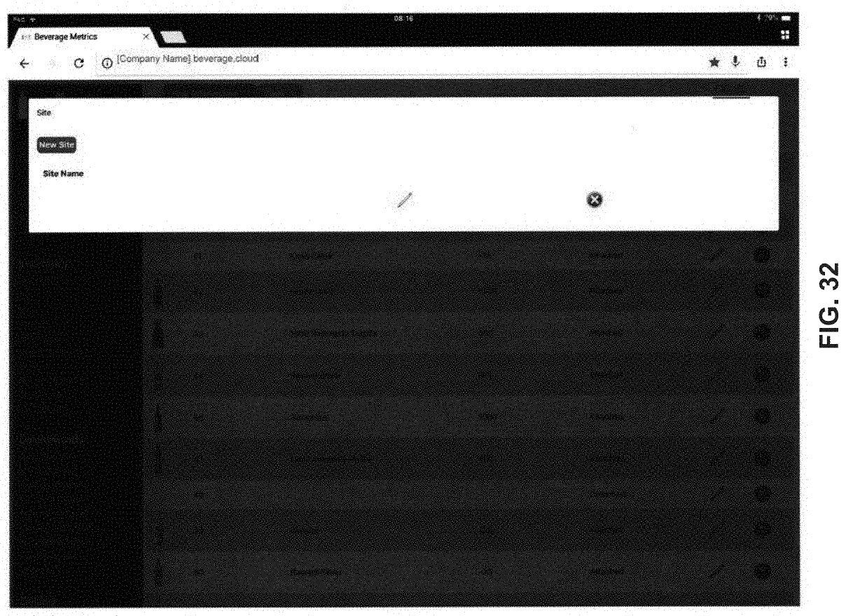

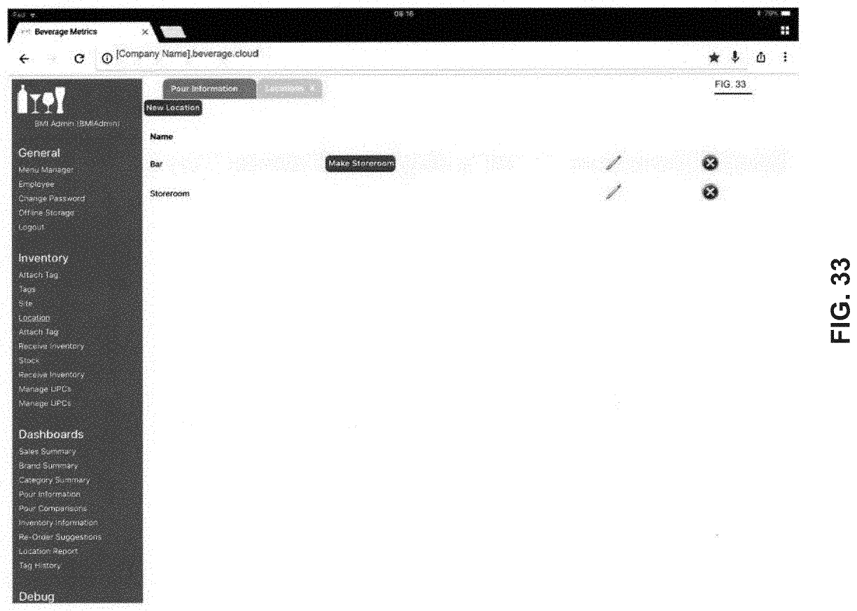

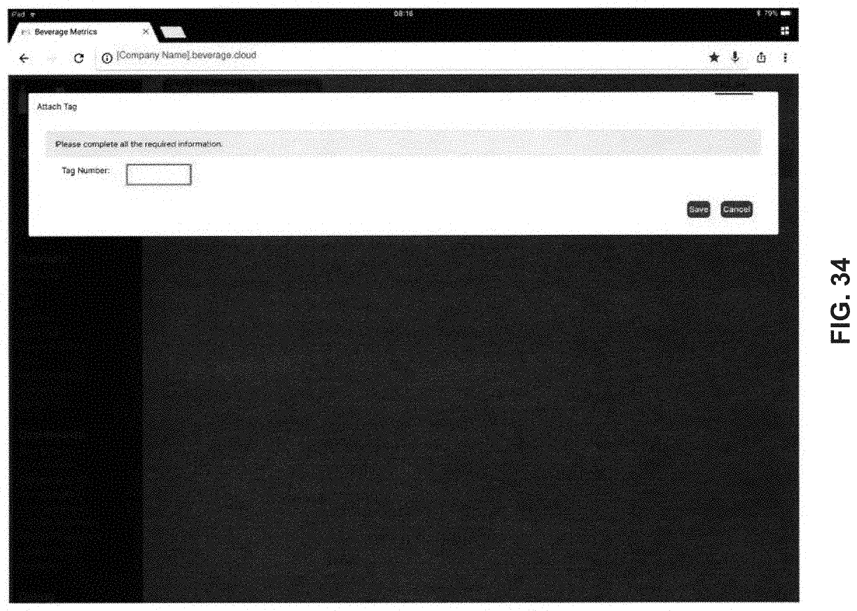

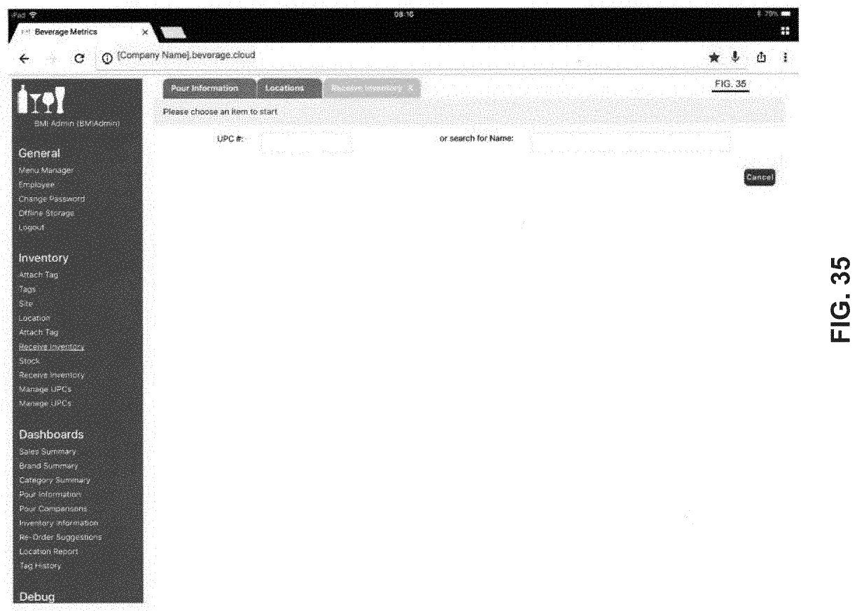

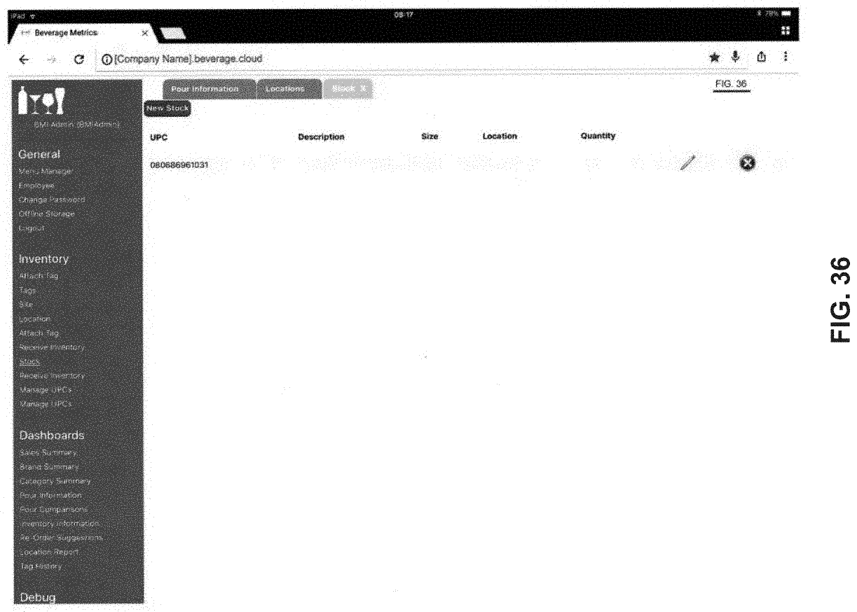

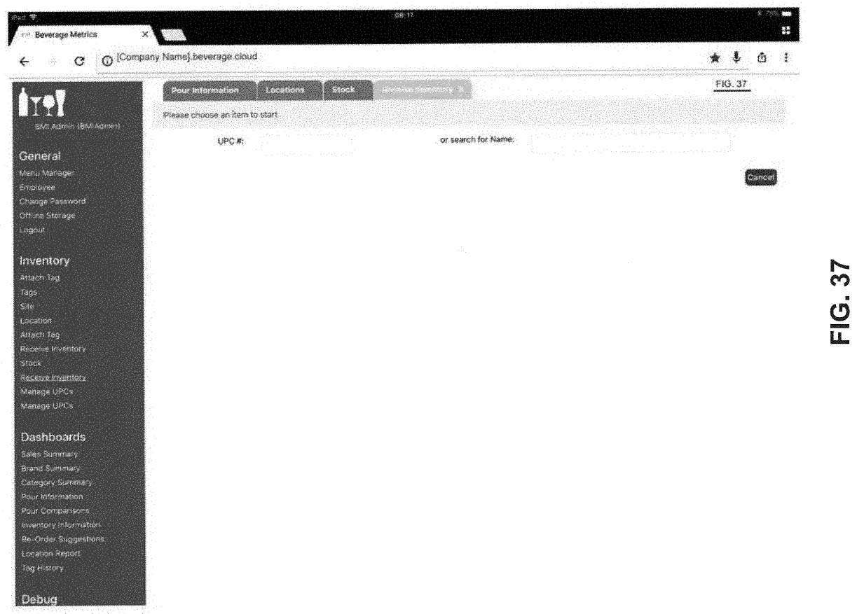

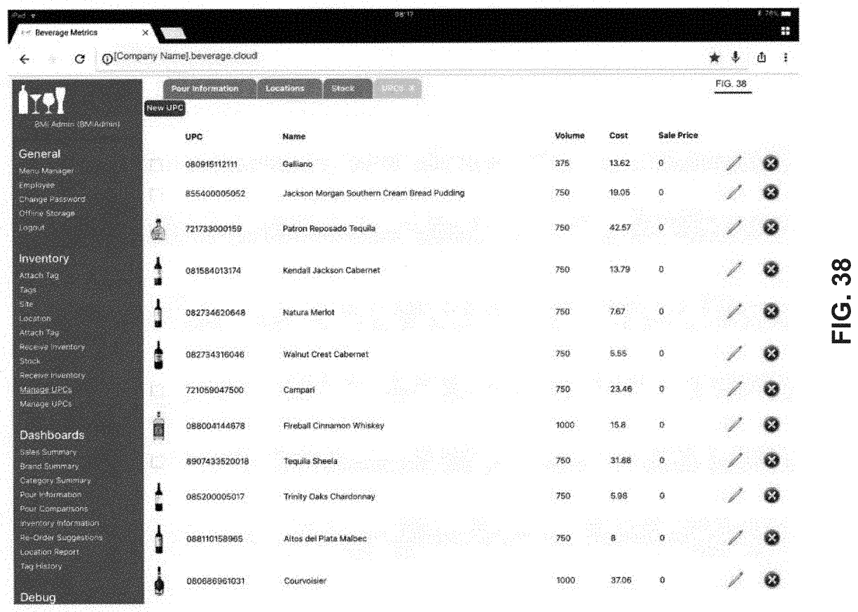

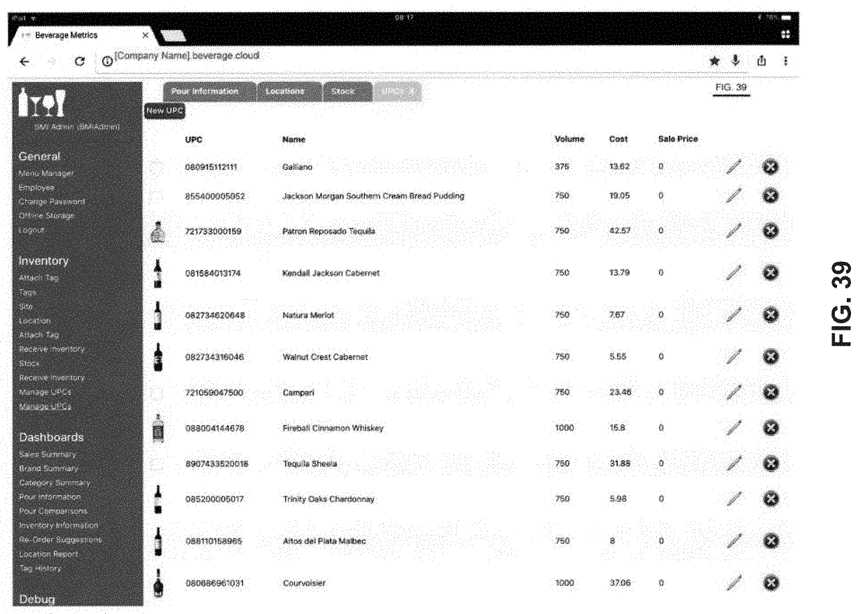

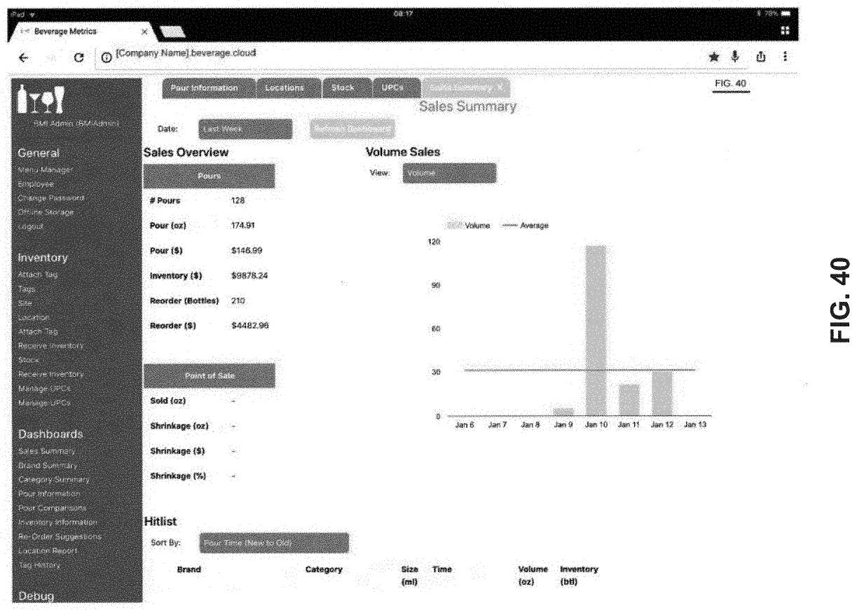

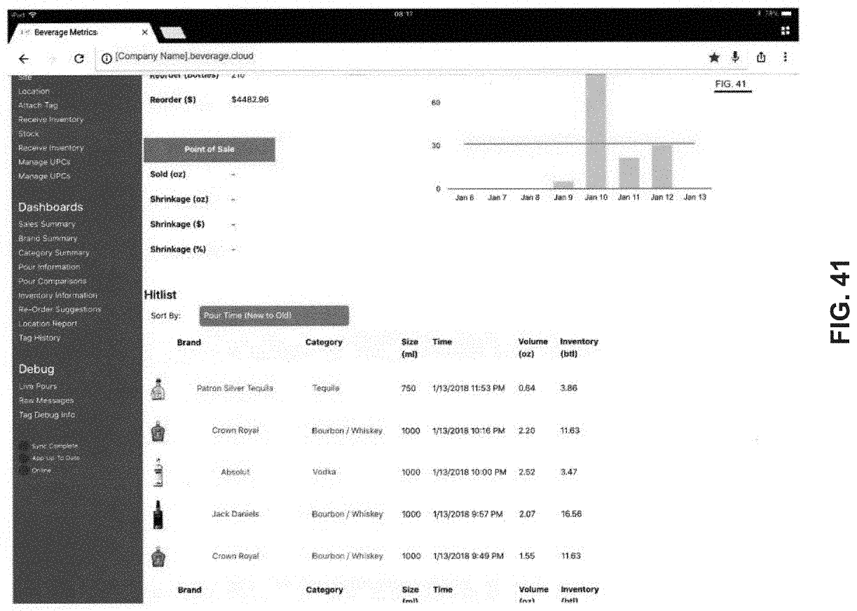

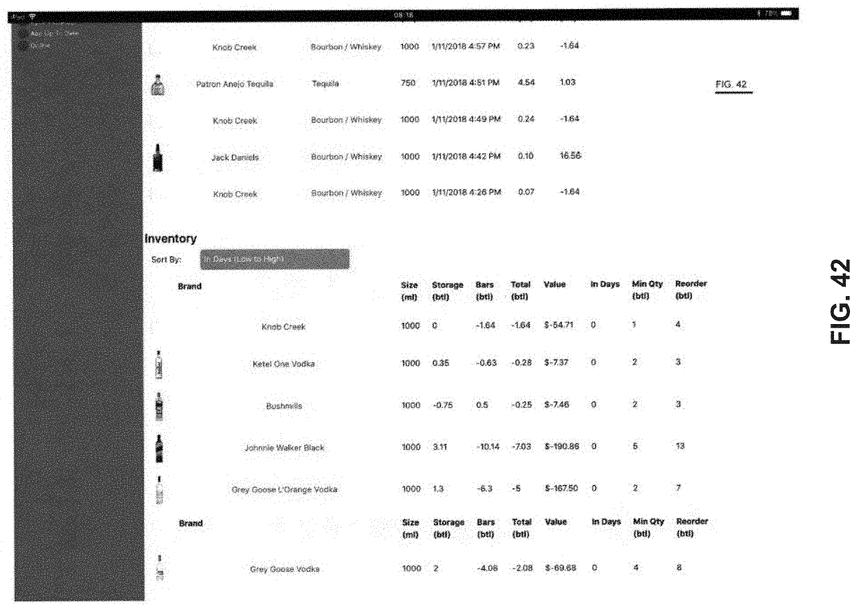

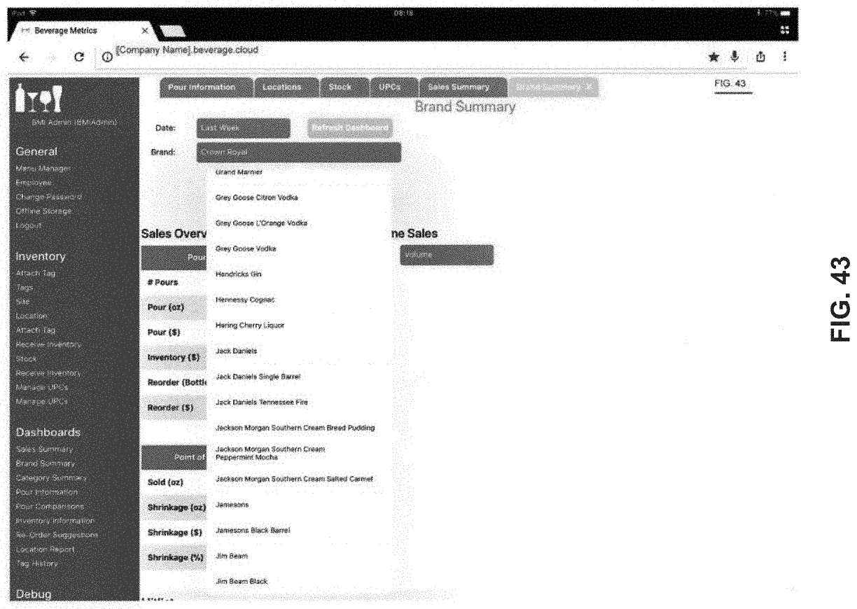

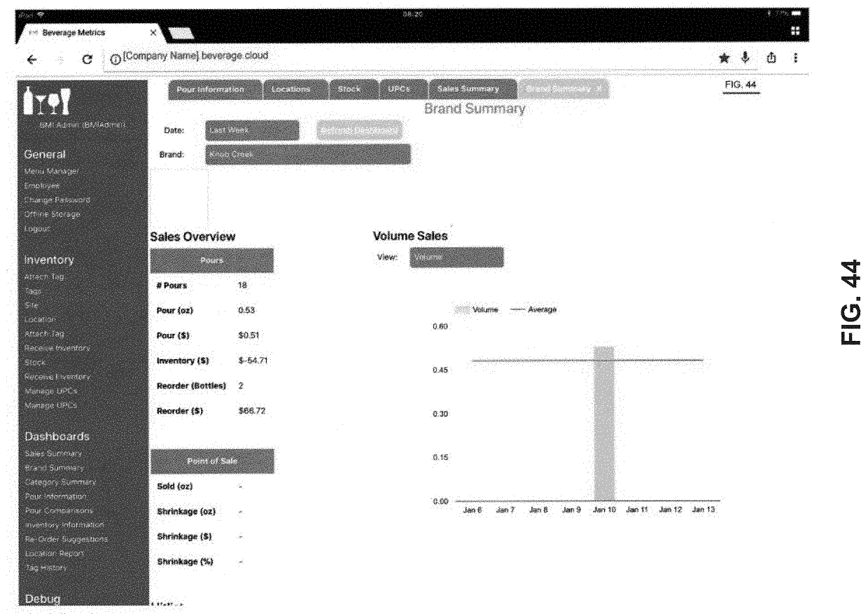

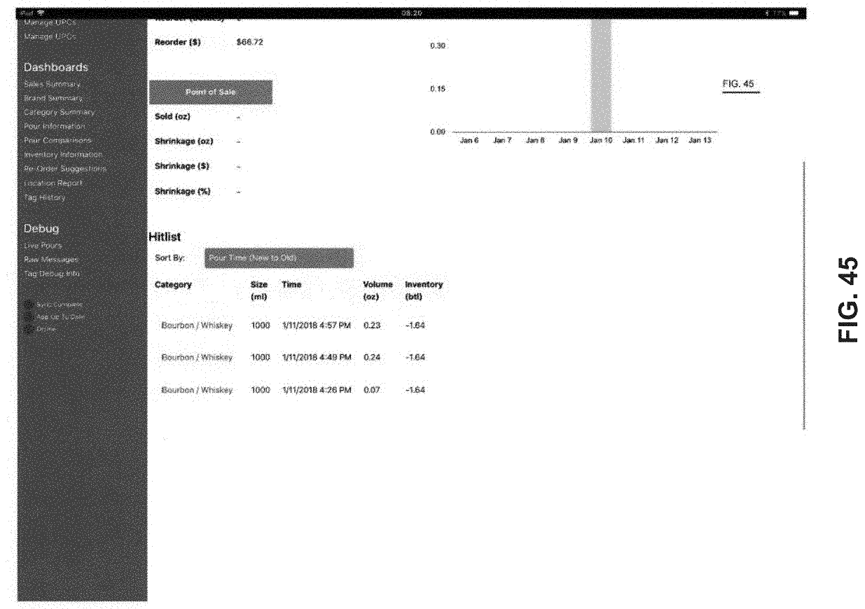

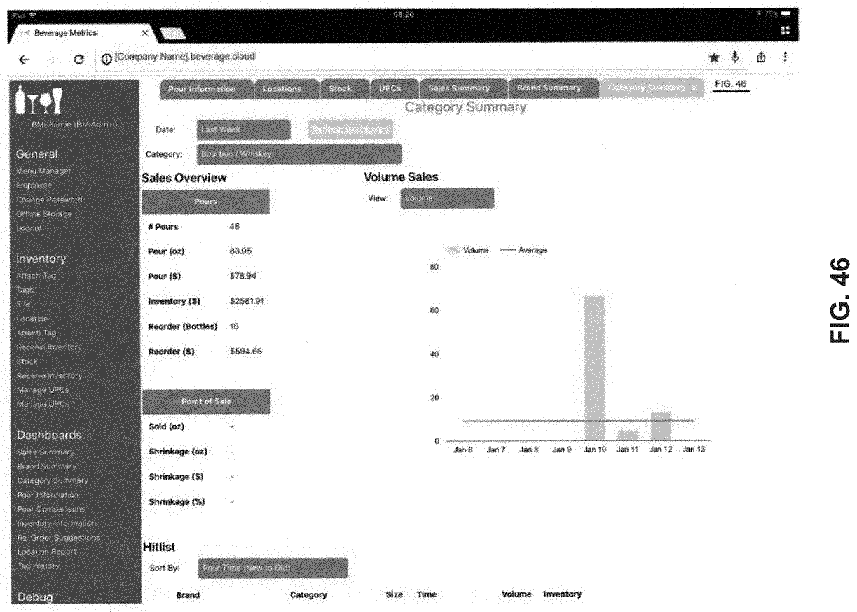

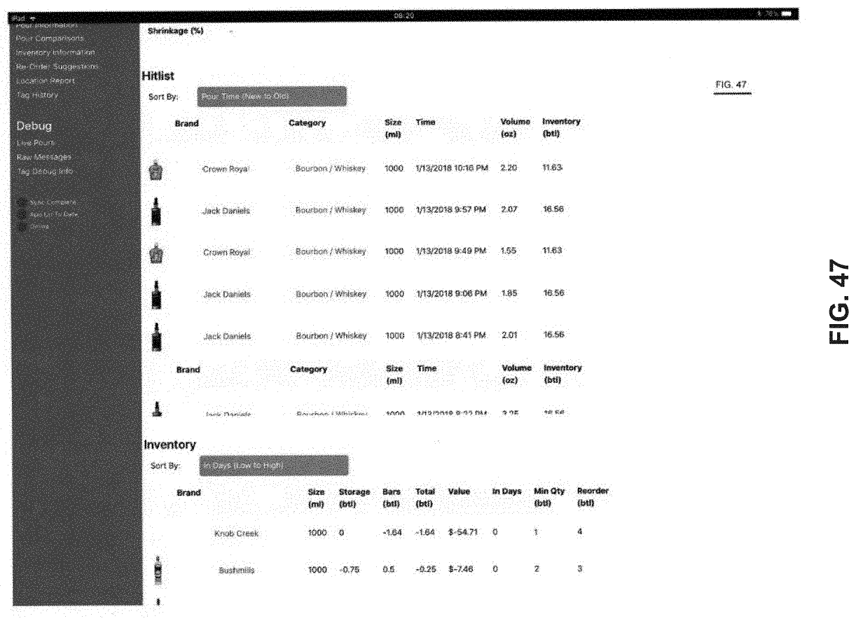

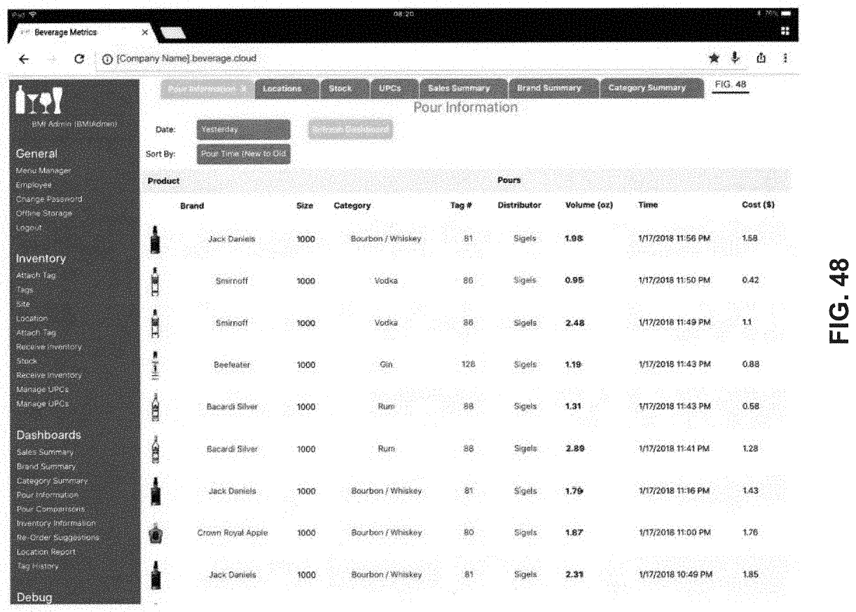

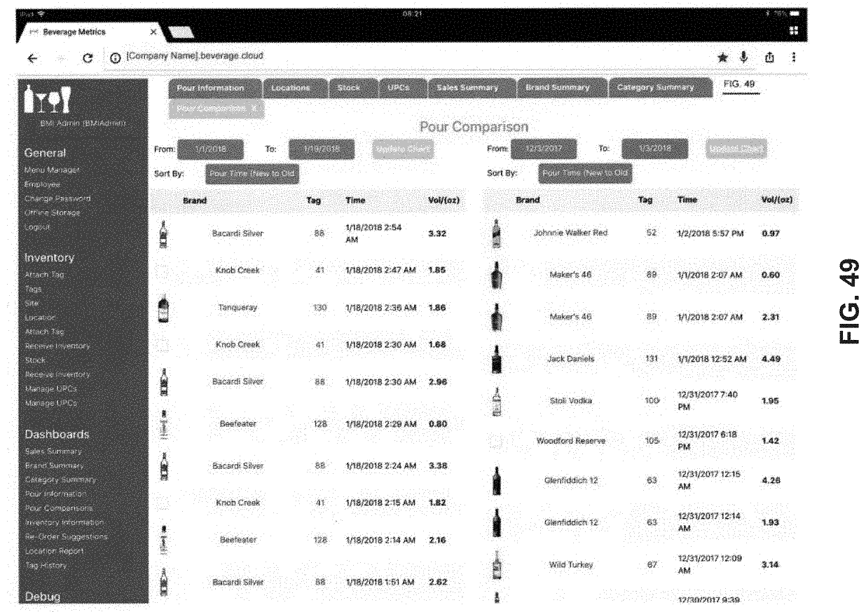

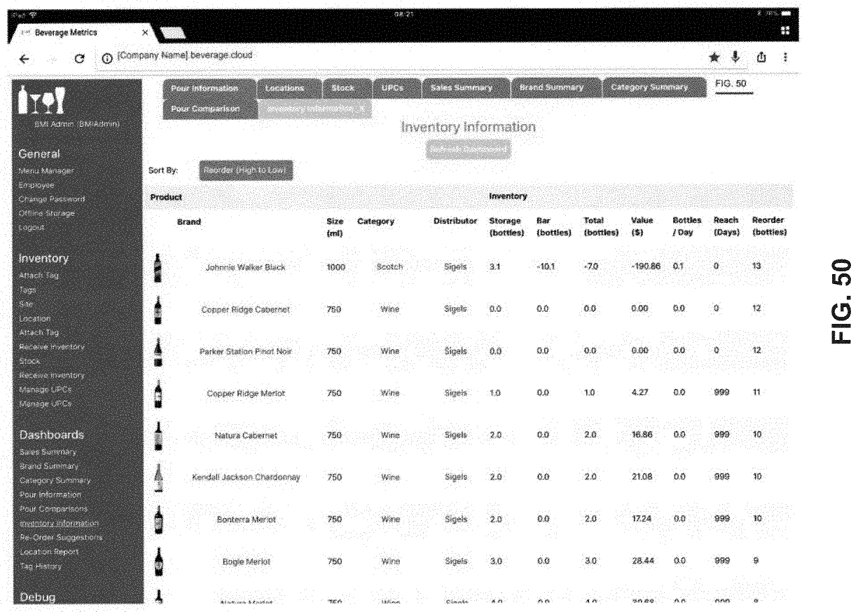

FIGS. 5A to 51 shows an example embodiment of the tag or tag pack used in an embodiment system of the present invention. FIG. 5A shows a front view of a tag's housing including a QR code containing information on the bottle or object that the tag housing is to be or is attached to. The QR code can be on a sticker or other surface which is either situated near to or disposed on a tag or chip or other device. The tag or chip or other device includes circuitry that stores and communicates tilt, pour, time, and other data to a system embodiment. See, for example, the tag or chip or other device embodiments described herein. The tag housing can be manufactured out of one or more of a variety of plastics, metals, rubbers, and other materials. For example, the tag housing holding the tag or chip can be made of plastic or other material that is infrared transparent for the proximity sensor. For example, the tag band part (portion that appears to be a partial circle in order to fit onto a bottle or object) can be made of silicon or rubber to allow for a certain elasticity and grip onto a bottle or object when fitting the tag or tag housing to the bottle or object. FIG. 5B shows a right side view of a tag's housing. Certain lines from manufacturing can be seen in this figure and other figures, but are not an included portion of the design. FIG. 5C shows a back view of a tag's housing. In this figure, there is a small extra edge which extends from the tag housing over a small portion of the tag or chip device included in the tag's housing. FIG. 5D shows a left side view of a tag's housing. FIG. 5E shows a front-side perspective of a tag's housing with an example measurement showing. This measurement is for an example tag housing. The tag housings can be a variety of sizes, depending upon the tag size to be included and/or the object to be attached to. FIG. 5F shows a front view of a tag's housing with an example measurement showing. FIG. 5G shows a top-front side perspective of a tag's housing. FIG. 5H shows a back-right side perspective of a tag's housing. FIG. 5I shows a right-side-bottom perspective of a tag's housing. In the figure, the ring or partial circle band connecting to the front portion of the tag housing is shown connected at higher than the half-way measurement point along the front portion. In an embodiment, that connection can be at the half-way measurement point along the front portion or the lower-than half-way measurement point along the front portion.

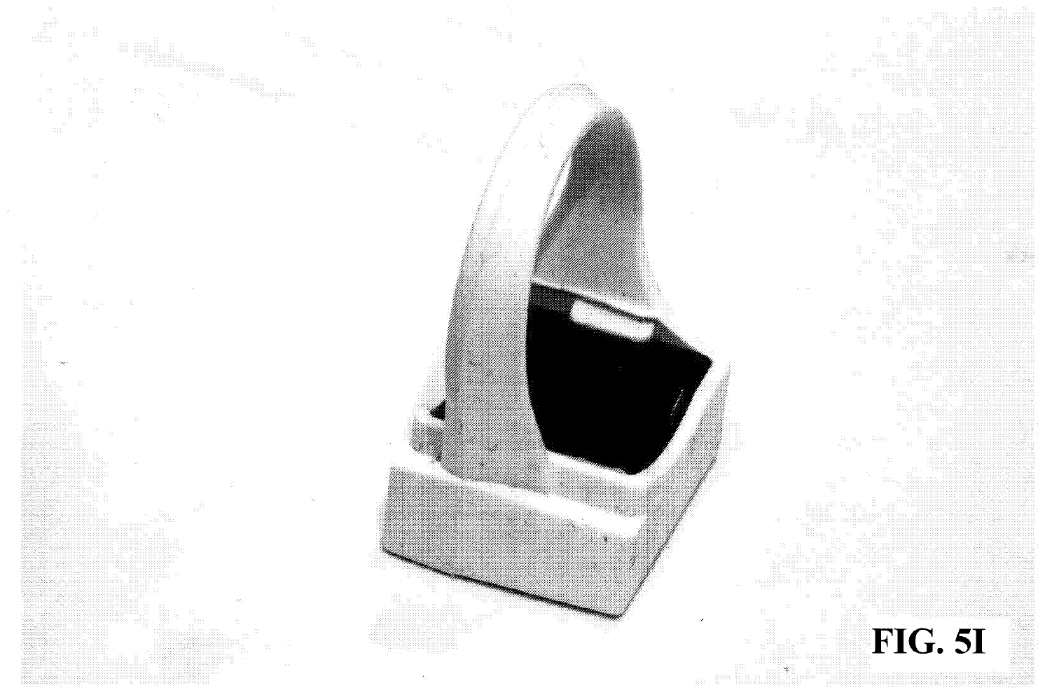

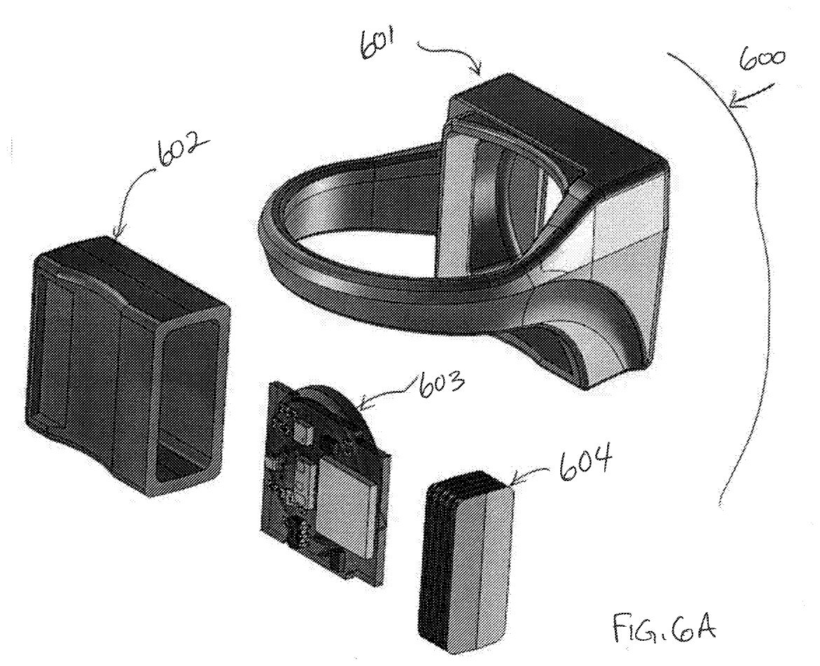

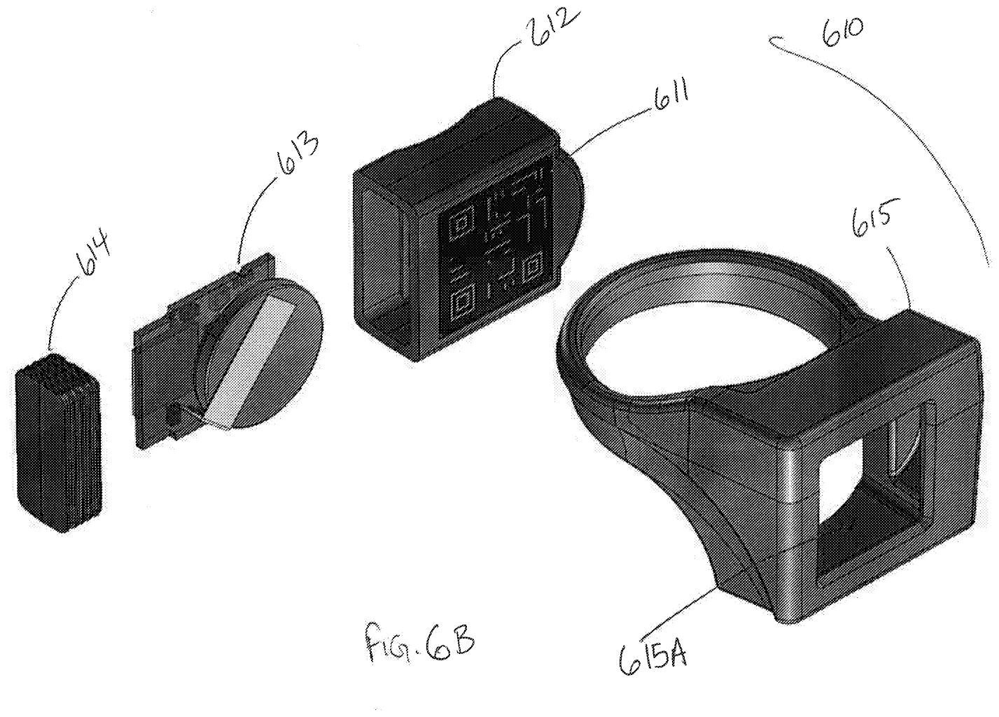

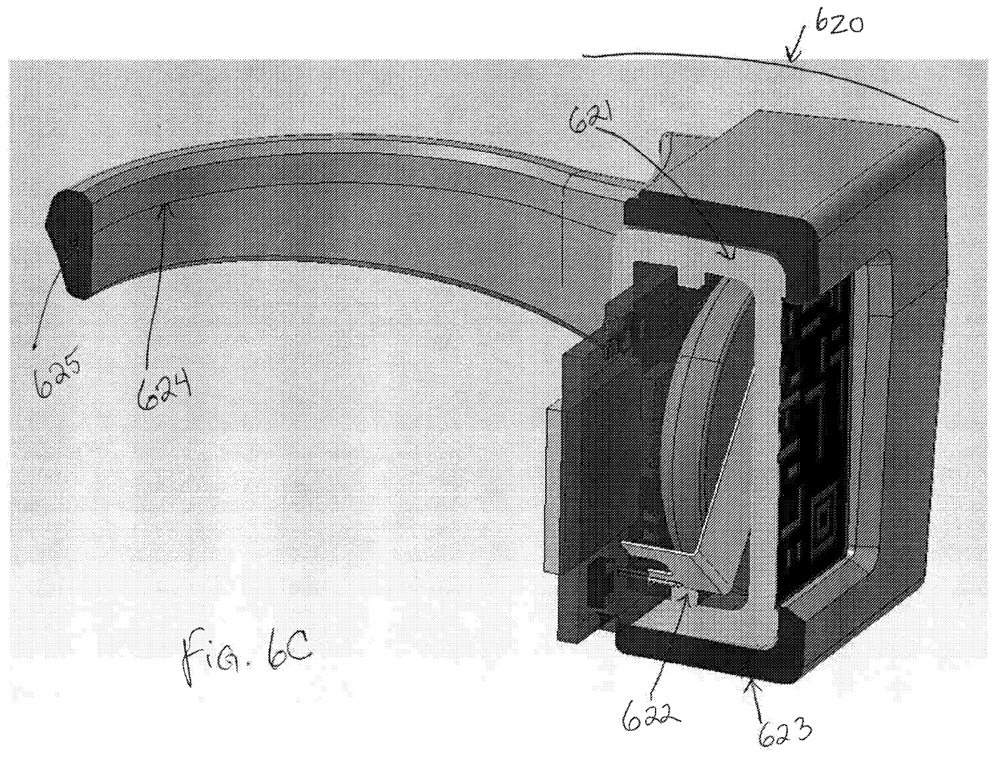

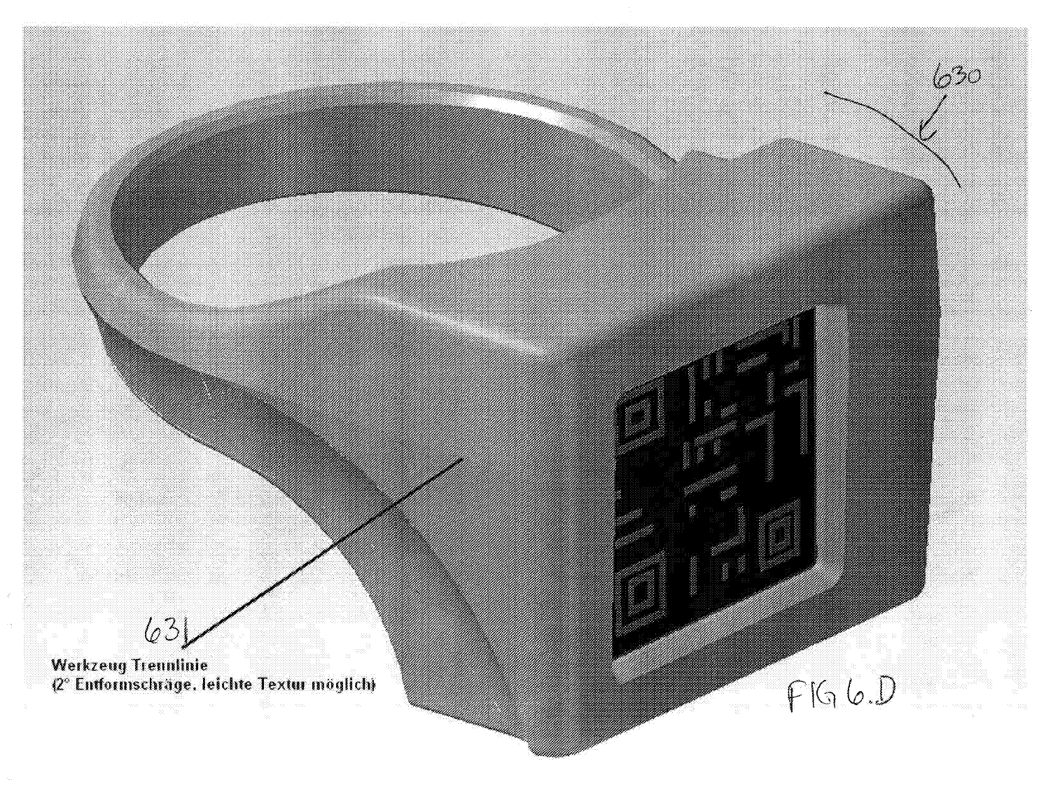

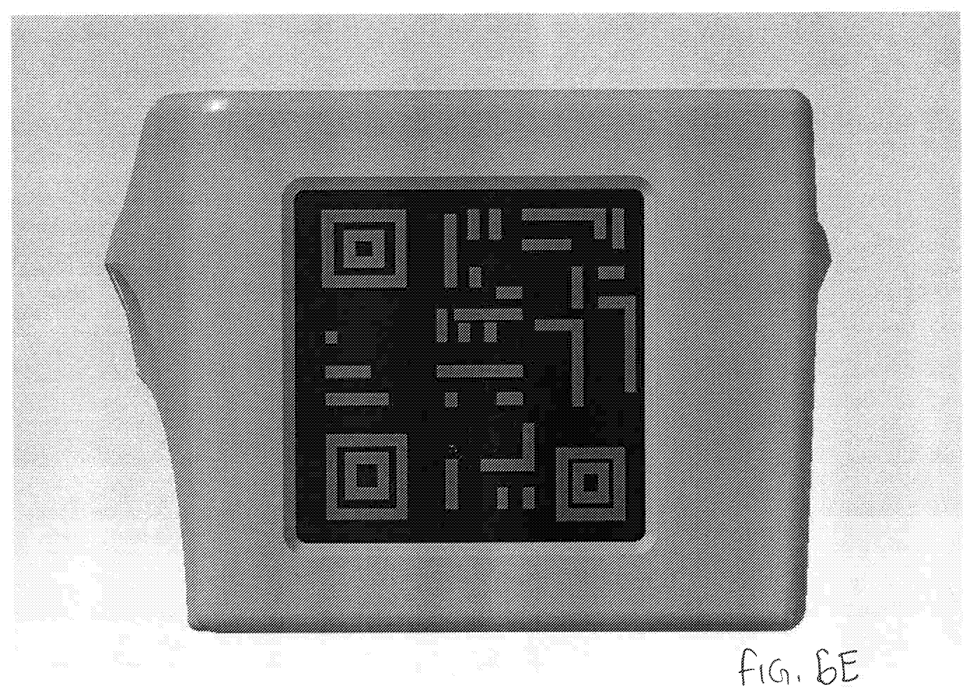

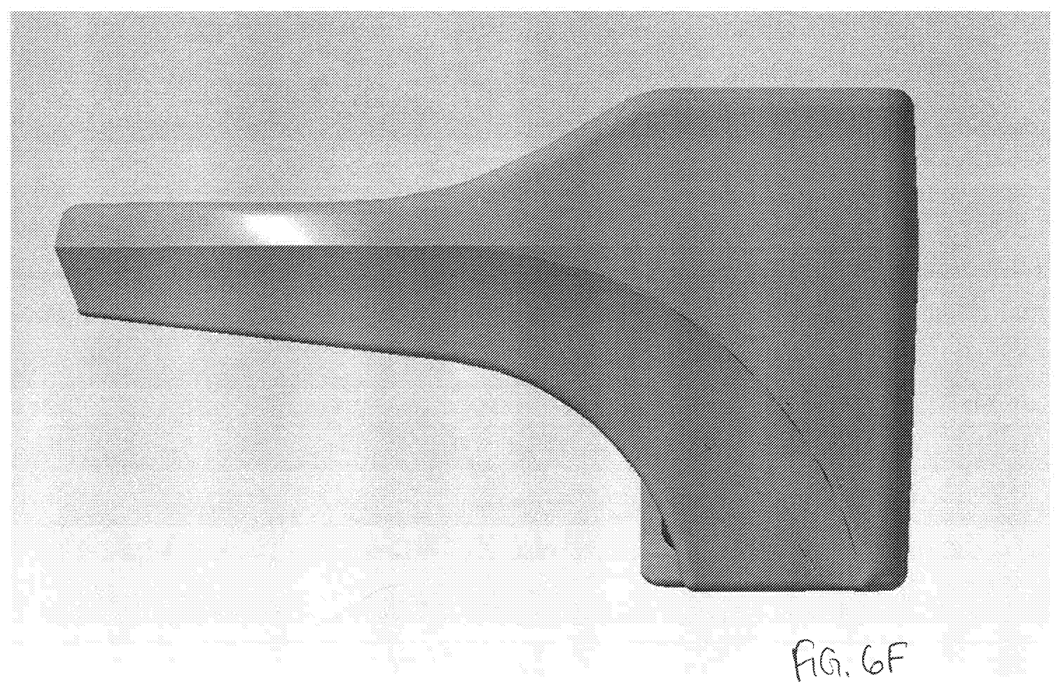

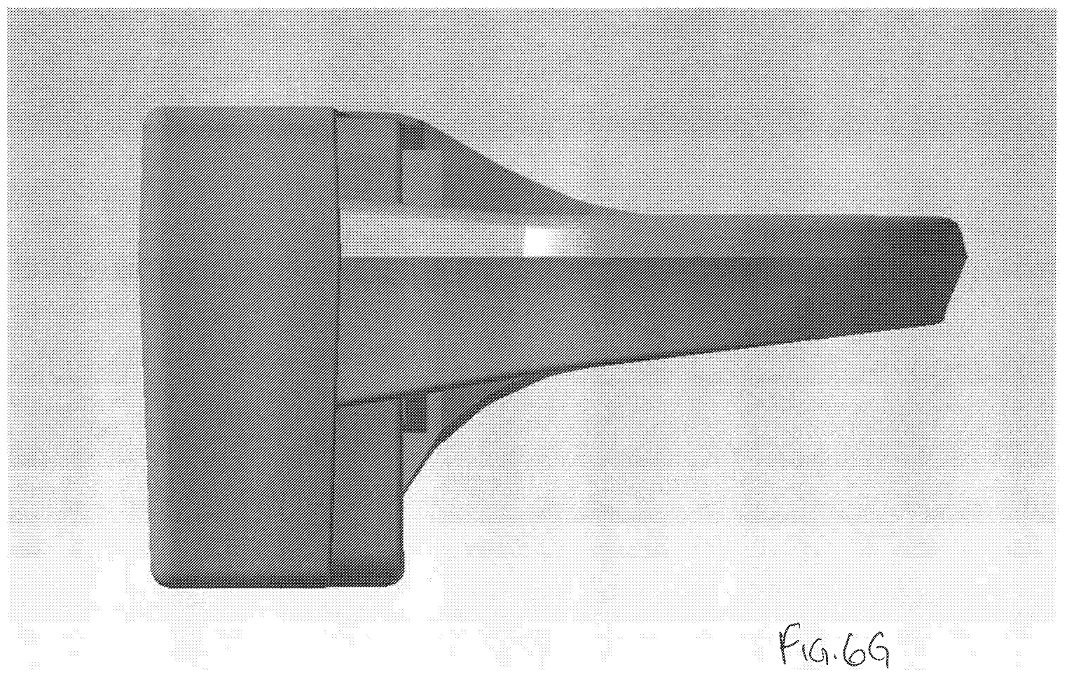

FIG. 6A shows an example embodiment of a tag pack 600, i.e., tag 603 and housing 601, of the present invention. The tag pack includes a holder 602 of tag 603 and a stopper 604 to keep the tag 603 in the holder. The holder 602 with the tag 603 and stopper 604 all fit into the tag housing 601. In an embodiment, the holder 602 is a black plastic which is IR transparent or other IR transparent material. In an embodiment, the stopper 604 is a rubber or silicon or other elastic-like material. In an embodiment, the band portion of the tag housing 604 is a rubber or silicon or other elastic-like material. FIG. 6B shows an example embodiment of a tag pack 610 from the front side, having a tag housing 615 with an opening 615A, a tag holder 612 having an opening 611 or a protrusion 611 to account for a battery (or other feature) of the tag circuit 613 and a stopper 614. In an embodiment, the battery is a rechargeable or changeable battery. The tag holder allows for the extraction of the battery from the tag pack. The opening 615A is provided to allow for a display screen on the tag holder 612 or a QR code display or other display on the tag holder 612 which is inserted into the tag housing 615. For example, the QR code display or other display could be 15.5 mm×15.5 mm for a QR code or bar code label of 15 mm×15 mm, to display through the opening 615A of the same or similar measurement. FIG. 6C shows a tag pack 620 having a band 625 made of an elastic or gripping type of material, the bad 625 can include one or more ridges 624 to increase the grip of the band. The tag has a holder 621 shown in a cross section view, with certain uplifted edges 622 to assist in keeping the tag features stationary or set. The tag housing 623 can be a harder material than the band 625, in order to keep straight and stationary (and to protect) the tag circuit. FIG. 6D shows an example tag pack 630 having a texture line 631 from the manufacture of the tag housing. The tag housing can be 3D made or made via a set mold or other method. In an embodiment, the tag housing is one piece. In an embodiment, the tag housing is more than one piece fitted together.

FIG. 6E shows a front side of the tag pack, displaying a quick response (QR) code, or multidimensional barcode or other display. FIGS. 6F and 6G show right and left side views of the tag pack. FIG. 6H shows a tag housing 660 having an upper edge 661, and a rest edge 662. These edges allow for keeping the tag holder in the tag housing, and for easy removal of the tag holder from the tag housing. FIG. 6I shows a horizontal cross-section of the tag pack, showing the tag holder and tag inside the tag housing. FIG. 6J shows a top view of a horizontal cross section of the tag pack 670, having space and/or elastic 671 allowing for movement when getting the tag holder out of the tag housing. The rest edge 674 (similar to the edge 662 of FIG. 6H), the stopper 673, and the holder edges 672 are also shown. FIG. 6K shows a front vertical cross-section view of the tag pack 680. There is an airgap all around 681 is shown to allow for manipulating the tag holder out from the tag housing. The edge 683 is shown for keeping features in place. Spaces 682 are also shown.

In embodiments of the present invention, in order to determine the amount of liquid poured from a container, e.g., a bottle (for purposes of illustration here), various features need to be known and/or measured as described further below.

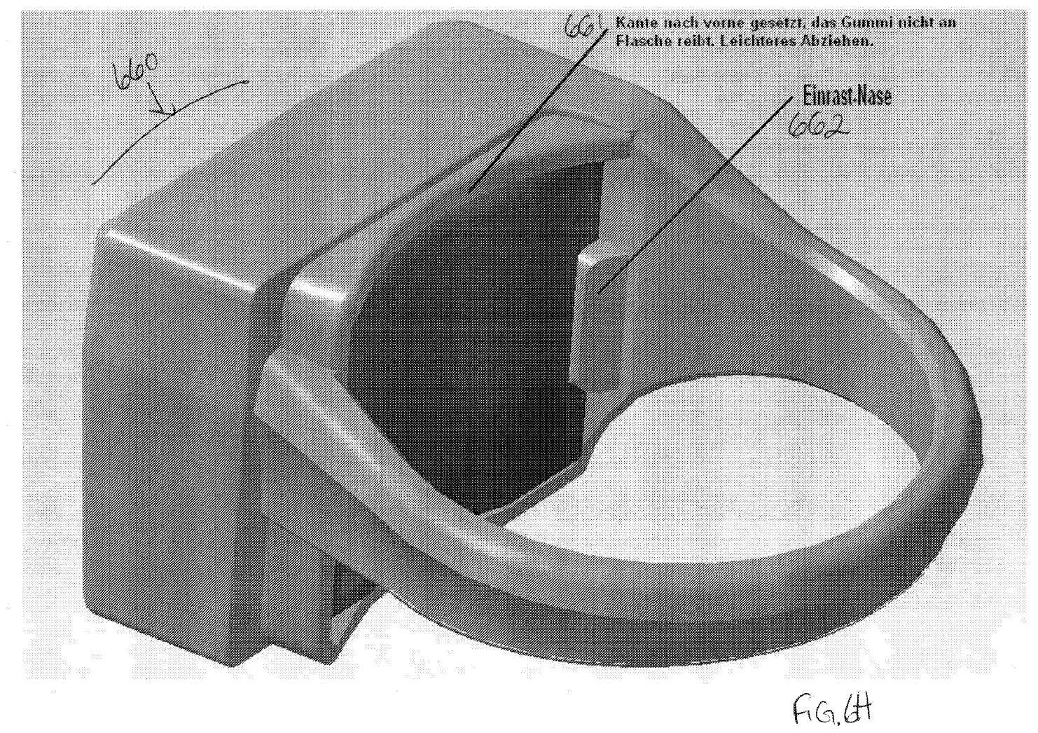

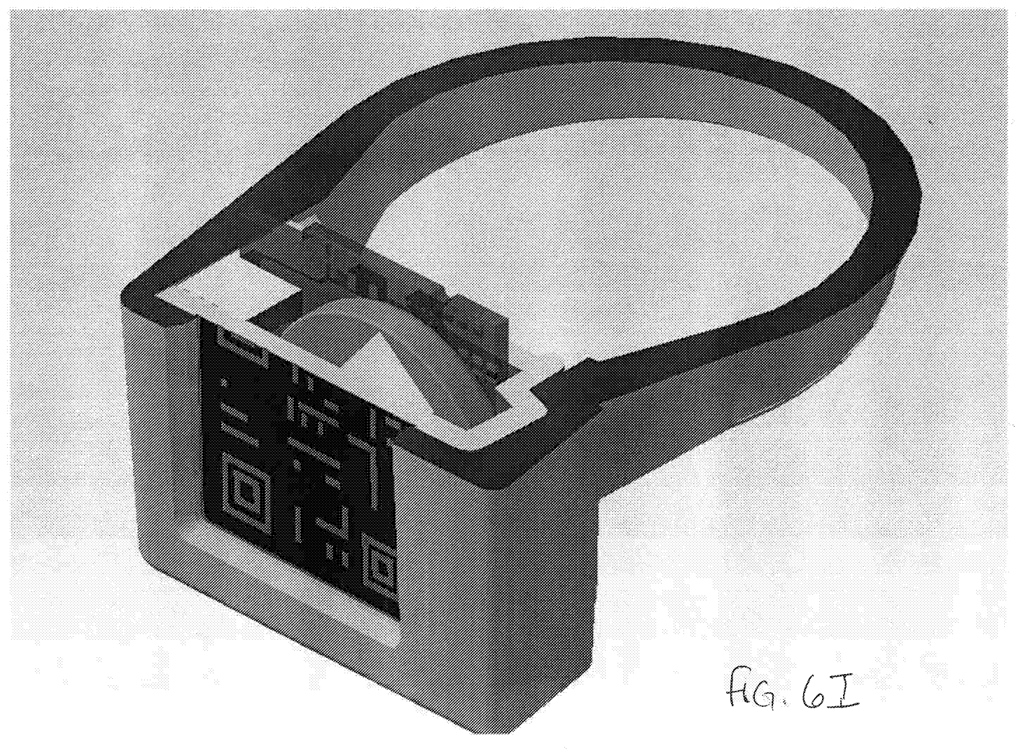

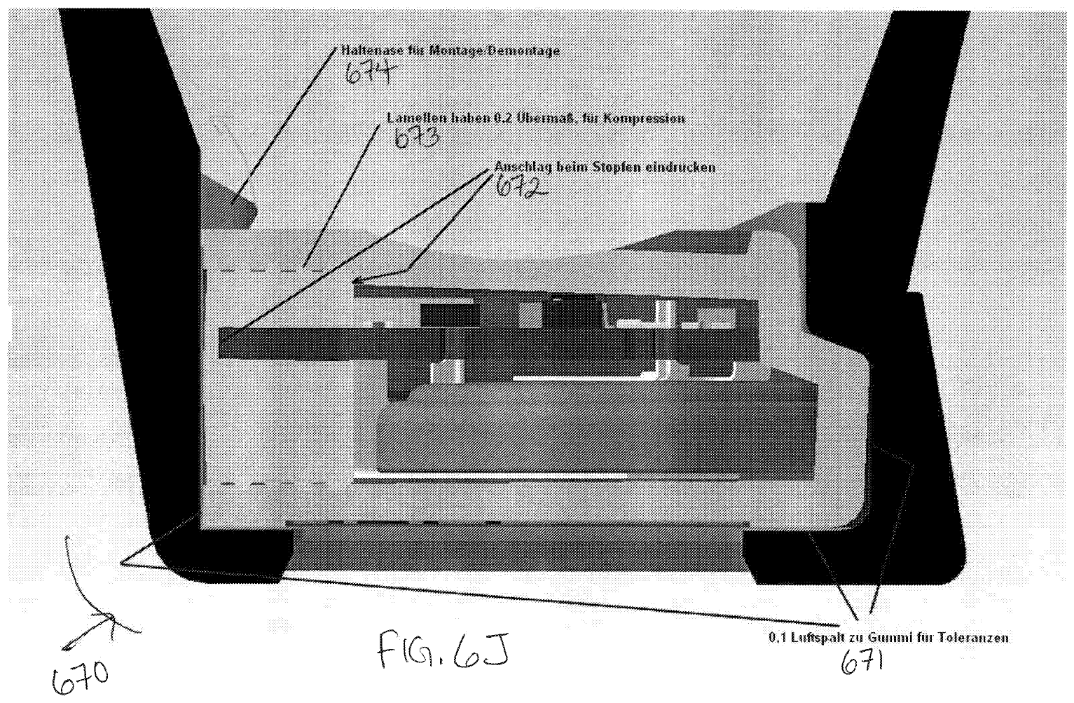

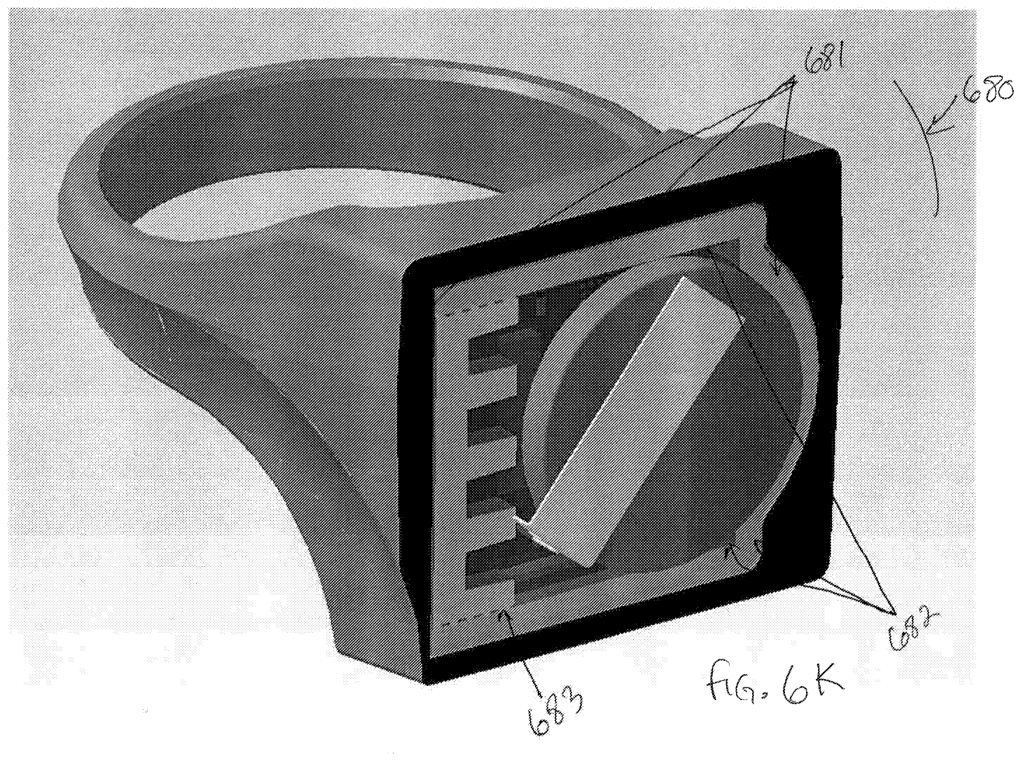

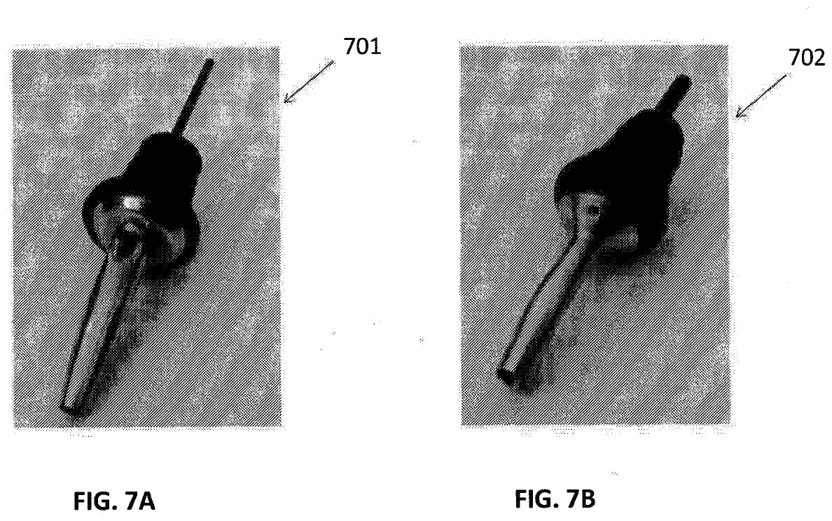

FIG. 7A shows an example spout 701 with a circular outflow of 5 millimeters (mm) in diameter that can be used in an embodiment of the present invention. In an embodiment, a specific algorithm calculating pour information takes into account that a bottle or container uses a spout for pouring, and specifically the circular outflow of the spout. FIG. 7B shows an example spout 702 with a circular outflow of 7 millimeters (mm) in diameter. In an embodiment, an algorithm or data generating process and system takes into account the size of the circular outflow of a spout attached to a bottle or container for pouring. In an embodiment, an algorithm or data generating process and system takes into account the types or viscosities of the liquid to be poured. For example, some types of liquids are: aqueous liquids, including vodka, rum, tequila, whiskey, wine, Cointreau, Grand Marnier, et al.; Baileys; Godiva liqueurs. In an embodiment, an algorithm or data generating process and system takes into account the size and shape of the bottle or container. For example, some bottles of different shapes include: Baileys; Cointreau; Godiva; Grand Marnier; Knob Creek whiskey; and wine bottle.

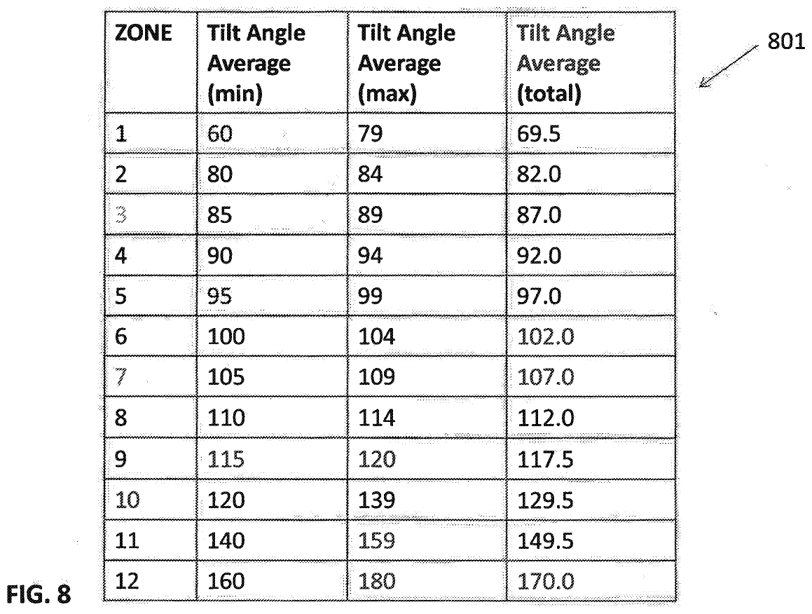

FIG. 8 shows a table 801 of angle zones of a tag or sensor disposed on a liquid container according to an embodiment of the present invention. In an embodiment of the present invention, in order to determine the amount of liquid poured from a bottle (or container), the tilt angle is measured over time by a sensor, or tag (as referred to interchangeably herein), disposed on the bottle. In an embodiment, an algorithm or data generating process and system takes into account the geometrical parameters of the bottle's shape and size, the initial liquid content, and the tilt angle, in order to determine the amount of liquid poured. Embodiments of the present invention provide systems and methods for handling bottles or containers with and without an attached spout. In an embodiment, the tilt angle of a bottle varies between zero degrees and 180 degrees. That is, if the tilt angle is zero degrees, then the bottle head or tip is vertically upwards. If the tilt angle is 180 degrees, then the bottle head or tip is vertically downwards. The sensor is measured as detecting at least twelve angle zones as listed in FIG. 8. In an embodiment, an algorithm or data generating process and system takes into account the tilt angle, and where available, the average tilt angle for a specific zone.

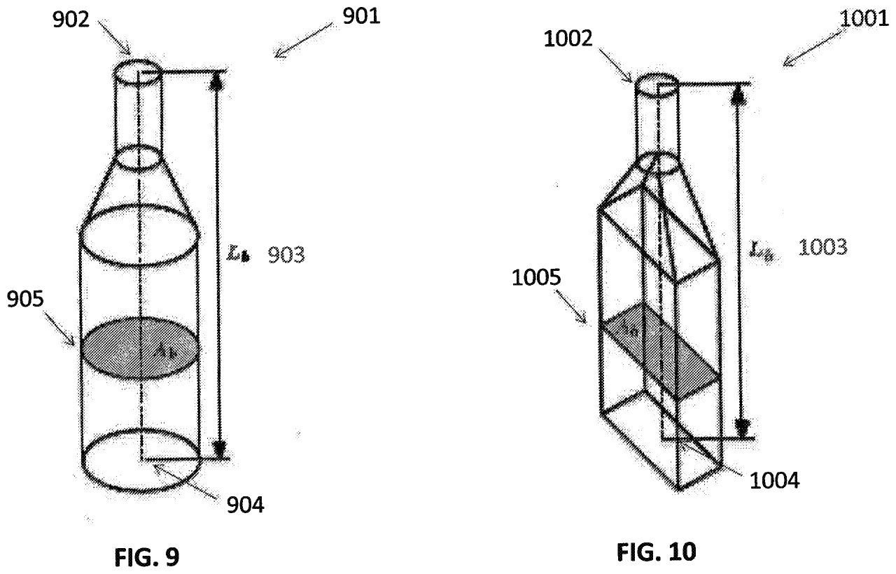

FIG. 9 shows a schematic sketch of a cylindrical bottle 901 according to an embodiment of the present invention. The bottle 901 has a tip or head 902, a length 903, a bottom 904, and a cross-section 905 of the center portion of the bottle. From the cross-section, the circumference and diameter can be determined. FIG. 10 shows a schematic sketch of a rectangular bottle 1001 according to an embodiment of the present invention. The bottle 1001 has a tip or head 1002, a length 1003, a bottom 1004, and a cross-section 1005 of the center portion of the rectangular bottle. The length and the cross-section are parameters needed for use in determining how much liquid has been poured as described further herein.

In embodiments of the present invention, various algorithms or data generating processes or systems are described herein. For example, Formula A for a pour from a bottle having an attached spout is as follows:

$${V}_{pour} = 100 \cdot {A}_{sp} {\sum }_{i = 1}^{12} {v}_{i} {t}_{i} - C \sqrt{{L}_{b} - \frac{{V}_{ini}}{{A}_{b}}}$$

In this embodiment, the parameters include: Vₚₒᵤᵣ as the poured liquid volume and measured in milliliters (ml); Vᵢₙᵢ as the initial liquid volume in the bottle before the pour and measured in milliliters; Aₛₚ as the cross section of the spout at circular outflow and measured in square centimeters (cm²); A_{b} as the cross section of the lower or largest diameter portion of the bottle and measured in cm²; L_{b} as the length of the bottle and measured in centimeters; vᵢ as the outflow velocity in zone i where f(tilt angleᵢ, spout, liquid) and measured in meters per second; as time in zone i and measured in seconds, and C as empirical constant where f(spout, liquid) is measured in cm^{3/2}. The first term on the right hand side of the above formula represents the outflow of the liquid through the spout. Aₛₚ represents the outflow cross section of the spout, which is for a circular cross section, calculated by πDₛₚ²/4, where Dₛₚ is the diameter of the circular outflow cross section. For example, for a Dₛₚ of 5 mm and 7 mm, cross sections Aₛₚ of 0.19635 cm² and 0.384845 cm², respectively, can be obtained. The average outflow velocity in an angle zone i is shown as vᵢ. In experiments, it was found in emptying experiments that the outflow velocity is constant, for a given spout, liquid and tilt angle, independent of the initial liquid volume in the bottle. It was found that the correlation between emptying time and the poured amount of liquid appears to be linear, i.e., constant velocity. Further, it was found that the emptying time appears to be independent of the shape of the bottle, when conducting an experiment using a wine bottle, Cointreau bottle and a Knob Creek bottle.

In conducting emptying experiments, it was found that the experimental outflow velocity v is approximately constant at large tilt angles, e.g., greater than 140 degrees. It was found that the experimental outflow velocity v decreases linearly with decreasing tilt angle. In order to match actual pours effectively, the average velocities vi are optimized by least squares fitting of the above Formula A equation to experimental pours, where the amount of poured liquid is measured with a weighing scale, with the restriction that the resulting velocity profile has to be in the same range and of the same shape (constant velocity at large angles and linear decrease with decreasing angles) as that obtained by the emptying experiments described above.

In embodiments with large pours, one can assume an essentially constant outflow velocity. However, where there are small pours, the acceleration of the liquid in the bottle has to be accounted for as well. In Formula A, the second term on the right hand side of the formula represents the influence of the acceleration of the liquid. The empirical constant C depends upon the spout and the liquid type. Such included parameters are gravitational acceleration and the outflow cross section of the spout. This is obtained via the least squares fitting of Formula A to experimental pours.

In FIGS. 9 and 10, the length of the bottle L_{b} and the cross section of the main lower part of the bottle A_{b} are shown and taken into consideration in Formula A. If the main lower part of the bottle is not cylindrical or constant mainly in shape, and instead is conical or curved in different ways, then an average value for A_{b} is taken and used in Formula A. It has to be ensured here that Vᵢₙᵢ/A_{b}>L_{b} otherwise the square root would result in a complex number.

In validating Formula A, the results of the experimental pours were compared to the results of Formula A. The relative deviation [symbol] of the calculated pour Vₚₒᵤᵣ from the experimental pour Vₑₓₚ is defined by Formula B:

$$\tilde{τ} = \frac{{V}_{exp} - {V}_{pour}}{{V}_{exp}}$$

Note, the above also necessitated the use of a weighing scale and the knowledge of the density of the liquid poured. The average value μ of a discrete number of quantities Z is defined by Formula C:

$$μ ( \tilde{r} ) = \frac{1}{N} {\sum }_{n = 1}^{N} {\tilde{r}}_{n}$$

The standard deviation of σ discrete number of quantities Z from its average value μ is shown in Formula D:

$$σ ( \tilde{r} ) \sqrt{\frac{1}{N} {\sum }_{n = 1}^{N} {( {\tilde{r}}_{n} - μ ( \tilde{r} ) )}^{2}}$$

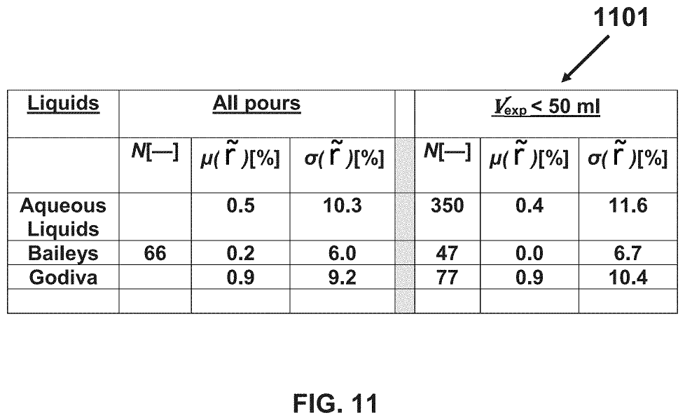

FIG. 11 shows example statistical quantities 1101 of beverage pours according to an embodiment of the present invention using a 5 mm spout on the bottle. In FIG. 11, N is the number of performed pours, μ( [symbol] ) is the average value of the relative deviation, and σ( [symbol] ) is the standard deviation of the relative deviation. On the left hand side of FIG. 11, all pours are represented. On the right hand side of FIG. 11, only pours smaller than 50 ml are shown.

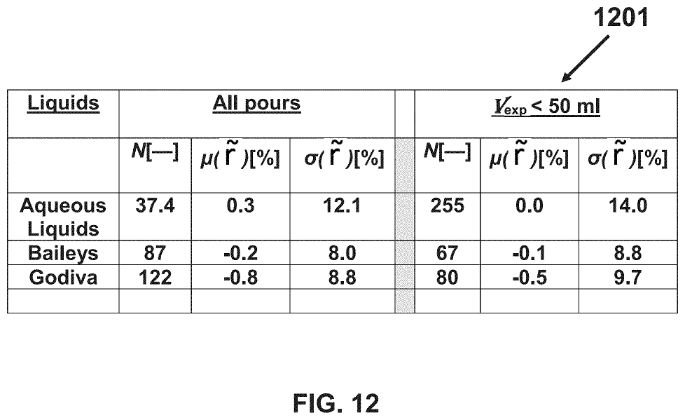

FIG. 12 shows example statistical quantities 1201 of beverage pours according to an embodiment of the present invention using a 7 mm spout on the bottle. In FIG. 12, N is the number of performed pours, μ( [symbol] ) is the average value of the relative deviation, and σ( [symbol] ) is the standard deviation of the relative deviation. On the left hand side of FIG. 11, all pours are represented. On the right hand side of FIG. 11, only pours smaller than 50 ml are shown.

The experiments were conducted with aqueous liquids in four different types of bottles, i.e., Cointreau, Grand Marnier, Knob Creek, and wine bottle. The experiments were also conducted with four different liquids, i.e., Cointreau, Grand Marnier, Knob Creek whiskey, and water. In FIG. 11 and FIG. 12, the statistical quantities corresponding to the direct comparisons made between the calculated pours and the experimental pours for the 5 mm and 7 mm spout are listed. The average values of the relative deviation μ( [symbol] ) were determined for all configurations within a range of ±1%, indicating a close agreement between the calculated and measured pours. The standard deviations σ( [symbol] ) were determined to be smaller than 12% for all experiments with the 5 mm spout. For the 7 mm spout, the obtained standard deviations are slightly larger (<14%) due to shorter time scales.

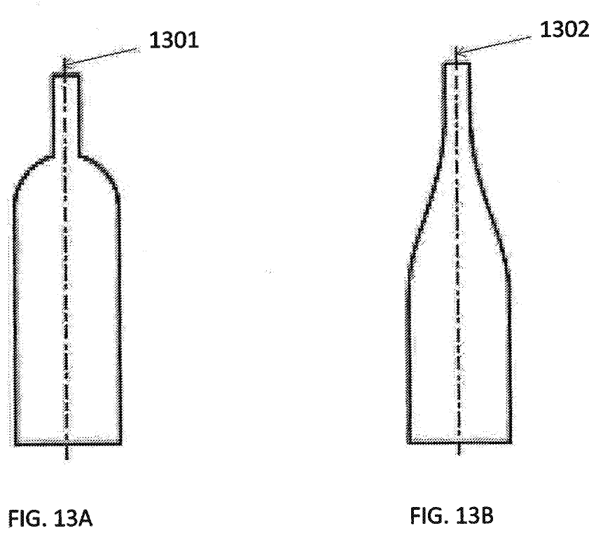

FIG. 13A shows a schematic sketch of a wine bottle 1301 used without a spout according to an embodiment of the present invention. The circular outflow of the wine bottle 1301 depicted is about 19 mm in diameter.

FIG. 13B shows a schematic sketch of a wine bottle 1302 used without a spout according to an embodiment of the present invention. The circular outflow of the wine bottle 1302 depicted is about 19 mm in diameter, and noticeably has a different cross section of the lower main portion from the wine bottle 1301 of FIG. 13A.

In embodiments of the present invention where there is no spout used on a bottle, the following Formula E can be used:

$${V}_{pour} = 100 \cdot {A}_{out} {\sum }_{i = 1}^{12} {v}_{i} {t}_{i}$$

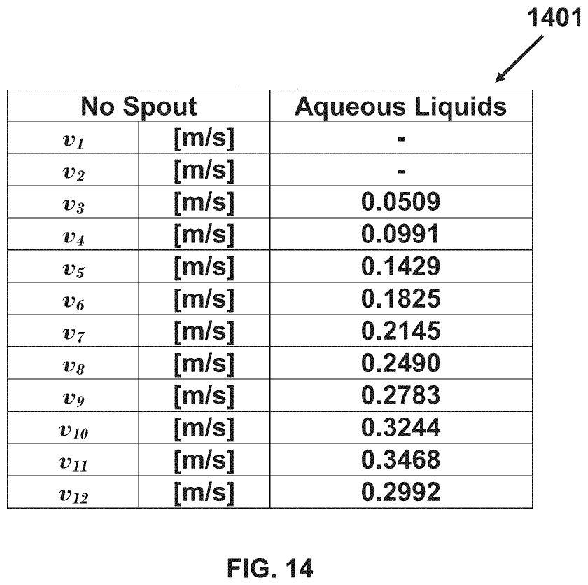

In Formula E, A₀ is the outflow cross section of the bottle. For wine bottles with an outflow of 19 mm in diameter, an Aₛₚ of 2.835287 cm² is obtained. As with the pours with a spout, the outflow velocity is assumed to be constant for a given liquid, outflow diameter and tilt angle, independent of the initial liquid volume. In order to optimize predictions of the amount of poured liquid, the velocity profile obtained by emptying experiments is fitted to the results of experimental pours. The resulting velocity profile values are shown in FIG. 14.

FIG. 14 shows example outflow velocities 1401 for beverage pours from a bottle without a spout such as that shown in FIGS. 13A, 13B according to an embodiment of the present invention.

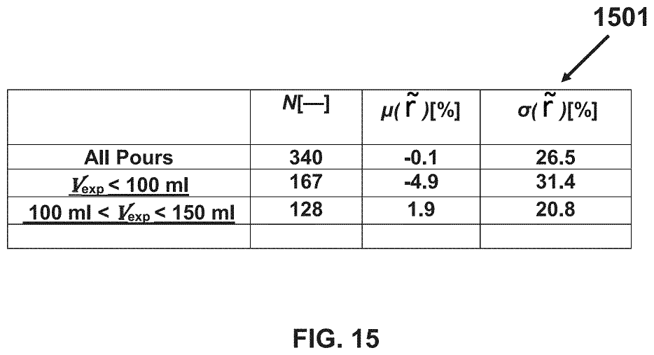

FIG. 15 shows example statistical information 1501 on experimental beverage pours from a bottle without a spout according to an embodiment of the present invention. In FIG. 15, N is the number of pours, [symbol] is the relative deviation of the calculated pour from the experimental pour, μ( [symbol] ) is the average value of the relative deviation, and σ( [symbol] ) is the standard deviation of the relative deviation.

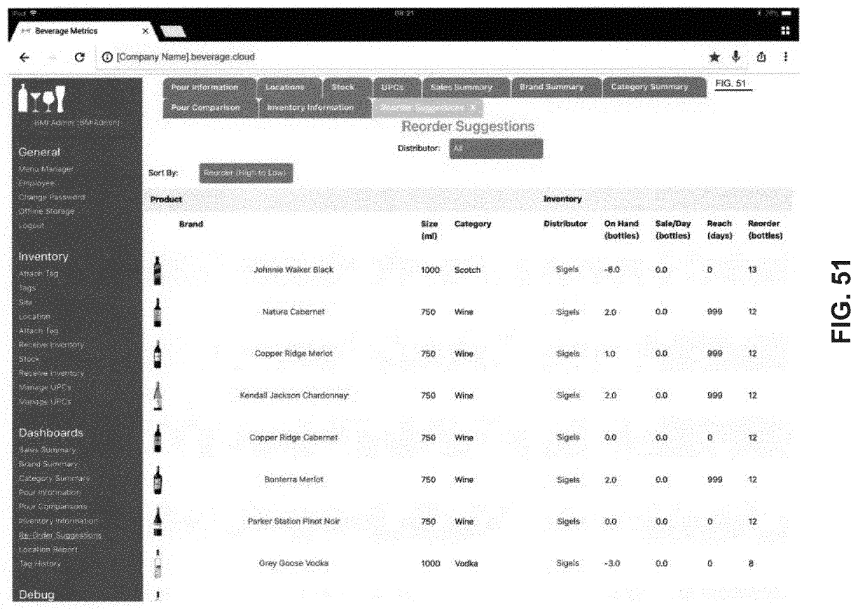

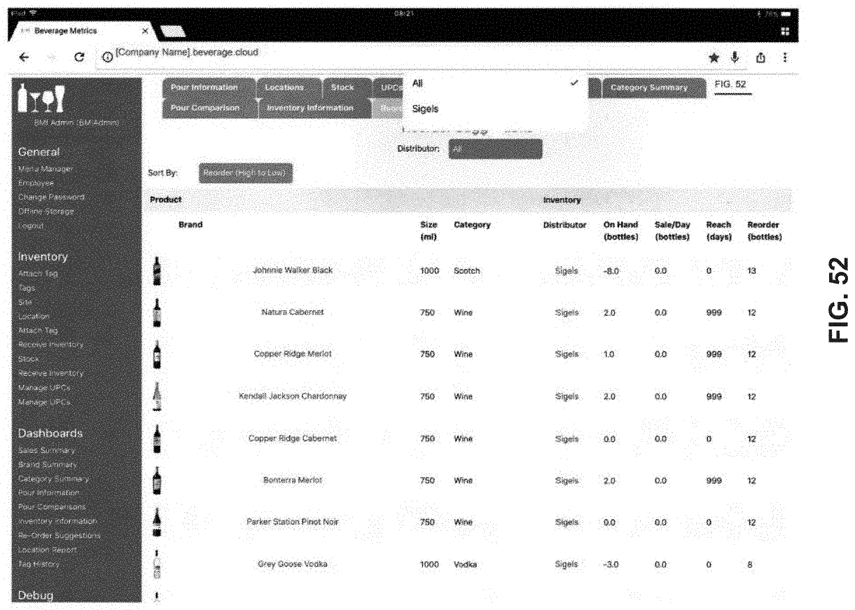

Embodiments of the present invention provide for an artificial intelligence (AI) solution by providing granular situation and response pairings, allowing for a company to obtain better forecasting for their business in inventory, usage, waste, and the like. For example, in the embodiments provided herein, example granular situation and response pairings are provided. For example, such AI provides for better forecasting, and thus, reordering as in FIG. 51.

In an embodiment of the system, users of the system can create an event, and track the various details useful to that specific type of event. For example, if an organizer needed to create a Banquet Event Order (BEO), then:

1. Create Event
Organizer creates the Banquet Event Order (BEO) to the specifications for the event.
   Organizer needs to be able to note the details that include what, when, where, who and budget of the event on the BEO.
      Organizer needs to be able to manually input details of the event into an organized format based on what the customer wants.
      System has an editable event form to create the BEO event.
         The following properties are recorded: Client name (first and last), event location, event date, number of guests. Free-text box for additional notes and file attachment.
         free-text boxes used for each requirement.
         User can modify the information at any time.
      Organizer needs to be able to retrieve the information I input at any given time.
      System can retrieve information for each BEO
         System can open each full BEO upon search of client name.
         System auto-fills search for each client name save in the system
         Search can also be filtered by event dates and locations.
   Organizer needs to be able determine if the event will be based on the consumer's consumption (premium) or a package (hosted). Organizer needs to be able to choose between the two options (premium or package deal) and add it to the even so can proceed to further details.
      System presents the user with options of package deals and prices.
         System has 2 options (premium VS. package). Drop down menu of different event packages once package option is selected including details that the organizer can edit.
         Free-text box for comments and notes. Made by organizer.
         User can edit details in packages such as products offered/prices/quantity. Can make special product requests based on client requests.
   Organizer needs to account the quality of product and pricing for drinks at the event.
      Organizer needs to be able to automatically get the sum of the prices of the products ordered on the system.
         System can automatically add the total sums of prices in packages or premiums based on products selected by organizer.
         Amounts so equal to adjustments made in real-time of editing.
         User can also change prices of products depending on business needs.
   Organizer needs to be able to import the BEO data into the app so can create the event.
      Organizer needs to be able to see each BEO on the app as well as all the details of each BEO.
         Each manager/organizer can see all the details of the BEO in organized manner.
         Once retrieved upon search, all necessary details for event set up will be presented.
         Organizer can add additional notes to BEO/highlight last minute changes to be made.
   Organizer needs to be able to determine how many bars will be at the event so that the appropriate amount of tags, spouts, mobile devices, supervisors, bartenders and runners needed for the event can be prepared.
      As a system, given that the number of hardware needed is already determined from the formulated BEO, system needs to be able to be able assign the stored hardware to each event so that I can track all the hardware based on usage.
         each BEO has pre-calculated number of tags and spout assigned to event.
         User is able to see how many of the total tags and spouts are assigned to each event.
         User is able to reassign hardware to different events based on demand.
      Organizer needs to be able to assign an adequate amount to staff needed in each event to ensure a smooth workflow.
         Each event has specific employees working including shift times.
         user is able to type in staff name/shift/role. Each staff will automatically have mobile device assigned to them
         User can add/remove staff and shifts based on demand and supply.

2. Initial Stocking of Bar
Organizer needs to be able to stock the bars (carts) on site for the event.
   Organizer needs to be able to add products needed on the BEO requisition by bar first and then have runners add the adequate amount of stock from storage to the bars.
      System needs to make real-time updates of the product requisition so that the runners can see the changes made and stock the bars accordingly.
         System specifies products name and quantity allocated to each bar with tag and spout.
         System shows name of product and quantity so that runners and managers can view them in apps in real-time.
         Managers can add and subtract product on requisition to relay to runners stocking bar.
   Runner needs to be able to add the stock from storage to the bars first and then add them to the BEO requisition.
      System allows the runner and storage-manager to manually input product added to the bars through the app to add to the requisition.
         The following properties are required on requisition tab: name/quantity of product present in bar.
         System updates product count in real time for managers/supervisors to see on apps.
         Able to modify the quantity of product on the requisition through the app after initially stocking bar.
      System automatically updates the requisition for tags that are in use but not added by the runner or storage-manager and send an alert to the supervisor when this happens.
         System can alert supervisor for tags unaccounted for in requisition.
         The alert is only visible in supervisor's device.
         Supervisor can acknowledge alert and make necessary changes.
   Bartender needs to be able to sign off on the requisition so that there is confirmation that the bar is fully stocked prior to the event.
      Bartender needs to be able to directly sign off on the requisition in the app after the bars are completely stocked.
      System acknowledges that the bars are completely stocked after the bartender has signed and close the requisition so no more modifications are made.
         Requisition is closed off and when bartenders confirm bar is stocked by signing
         User can sign off by inputting employee name and password at the end of requisition form.
         Once requisition is signed-off users cannot edit list without supervisor approval.

3. Live Event Process
Event employee (supervisor, runners, bartenders and storage-room manager) needs to manage bar in real time.
   Bartender needs to pour drinks and ring them up on the system.
      System acknowledges scanned tickets and marks them as used so they cannot be used again at the same event.
         Scanned tickets are marked off in system and no longer reusable.
         if drink is paid for without use of ticket, bartender's app is able to run credit cards as form of payment.
      Bartender needs a designated area to store used tickets.
   System measures drinks poured
      System receives information from the tags on exactly how much liquid is being poured from each bottle on every bar.
         System is updated on quantity of pour every time it is made.
         Alert made when pour deviates from standard.
         managers can change standard pour deviation alert.
   System calculates the reach of products so the system can automatically alert event employees to restock before it runs out.
      System locates each tag that is in use in each bar.
      System calculates how much liquid is left in each bottle after each pour made.
         Alert is sent to runner once a product refill is needed. Alert is sent to runner and store-room keeper device.
         product refill tab must be organized on name of product, quantity needed and location where it is needed.
         alerts removed once confirmed that bottle is retrieved by store-room keeper and new tag is active. System stores information on which bottle is sent out of the storage-room for records.
   Supervisor needs to be able to oversee via live updates the description and quantity of stock being taken from storage to the bars at the event.
      System shows on the supervisor's mobile device all the product movement being made from storage to event location organized by bar and product name.
         Live updates of movement of product from storage-room to bar and which runner is doing so.
         updates organized in manner wherein manager's device has a feed of product taken out from storage room and to which bar it is taken to.
         History is saved so supervisors can retrieve information of product movement.
   Supervisor needs to be alerted when the customer's credit limit is reached so I may offer an increase
      System recognizes when a credit limit is near.
         Supervisor is alerted on mobile device when limit is reached and has the option to increase the limit by any amount.
         User is able to type in an amount desired to increase limit and amount should be added on client's event account.
         limit can be changed at any time during the event and to any amount. Limits on premium can also be decreased from initial amount based on client preference.
   Client needs to see real time information of event.
      System shows the client details of the event.
         Client can pull-up event details which include the package they selected with the names and quantities of products selected in package.
         show totals of event purchased by consumer with real-time updates.
         Consumers can add or subtract items on event live requisition if they choose premium order and prices will add up simultaneously.
   As a customer I need to be alerted when my credit limit is reached so I may increase the limit
      As a system I need to be able to notify clients when their credit limits are reached.
         Client is notified on their view of event in app when credit limit is reached.
         Once client is notified they must first confirm notification then they will be able to proceed to editing credit limit.
   As a supervisor I need to be able to close a bar during an event
      As a supervisor I need to be able to alert the bartender that their specific bar will be closed.
         Supervisors can alert bartenders from their device to close the bar at any period during the event.
         Supervisors will be able to see if the bartender has confirmed alert.
         Supervisors will be alerted once bar is closed.
      Supervisors will be able to cancel and re-open closed bars during closing process and bartenders will be notified in real-time.
      As a bartender I need to be able to manually close the bar on my mobile device.
      As a system I need to be able to shut down a bar during an event.
      Bartenders will be able to close bar are receiving instruction from supervisor on app.
      once bartender confirms to close the bar they must immediately do so and system will no longer allow them to make pours and scan tickets without error alert.
      Bartenders will only be allowed to re-open bar if allowed by supervisor.
      As a system I need to be able to present all the information on product usage for each bar after it is closed.
         Given that the bar is closed and all activity is done then system will show activity summary on supervisor and bartender devices.
         Once bar is closed system will no longer allow pours. Event summary for each bar can only be viewed once bartender signs off that bar is close.
         supervisor must be able to approve that bar is closed as final step of process and information will be passed onto reports after reconciliation process.

4. Stock Transfer
As a runner—need to be able to transfer stock between bars following transfer protocol.
   As a supervisor—need to transfer stock from the store to a bar so that the bar never runs out.
      As a system—need to be able to allow supervisor to transfer product from closed bar to live bar.
         Supervisor can successfully request for product transfer from closed bar to open bar.
         Supervisor can view what product is left in closed bar and should have the option to alert runners to retrieve product form closed bar instead of returning to storage room.
         product stock on close bars must automatically update once product is transferred.
   As a runner—need to transfer the stock to the bar and have the bartender acknowledge the receipt
      As a system—need to be able to allow runner and bartender to confirm that product is transferred from closed bar to open bar.
         Runners and bartenders can confirm stock transfer once physical process is complete.
         system needs to update runners, bartenders and supervisors of transfers and update live even requisition in real time.
         This process can only be executed after approved by supervisor that transfer is available and will alert supervisor if completed without confirmation. All information of transfer must be saved and updated.

5. Event Conclusion
As a supervisor—need to be able to reconcile all the information on stock movement and consumption to verify reports after the event has ended.
   As a supervisor—need to be able to ensure that given that the bar is closed then there is no more movement of stock from storage to the bar.
      As a system—need to be alerted when movement is being made on bottles from a closed bar.
         When bar is closed and movement of product is made without permission, an alert is sent to supervisor.
         alert is made once activity of pour is recorded on tag from closed bar.
         the supervisor will be able to locate which bar is undergoing incorrect stock-transfer.
      As a system—need to be able to track the locations of the bottles (tags) being displaced from a closed bar without being accounted for.
         The supervisor will be able pinpoint location of tag so that it can be retrieved.
         Once alerted, option is made available for supervisor to track tag.
         Given that the tag locations are traceable then it will make having it accounted for easier.
   As a supervisor—need to be able to see if any pours are made from bottles once the bar is closed.
      As a system—need the tags to still continue sending me information of pours even after the bar is closed by the bartender.
         bottle content information is still retrievable after bar is closed and even is reconciled.
         Bottle content information is fed and stored in the house system at equal time intervals.
         When bottle contents are tracked after an event is closed but the bar hasn't been backstocked, then supervisors will be able to detect unaccounted pours.
   As a supervisor—need to ensure that partially used stock from a closed bar is returned to storage or an open bar after accounted for.
      As a system—need to be alerted by the tag once its placed back in the location of the storage-room.
         Once event is reconciled and bar is returned to stock room; removed tags will stay dormant until reuse.
         tag will continue to store information on use until taken off bottle. tags will be available for use at any time for any product once removed from bottle.
   As a supervisor—need to be able to ensure that empty used bottles are de-tagged and tags are accounted for.

6. Event Reports
As a user—want to be able to view reports before and after the reconciliation process.
   As a manager—to be able to search the BEO by name and event number so that I extract information for historic comparison.
      As a system—need to be able to retrieve stored information from reconciled events.
         managers and organizers will be to retrieve information from concluded events.
         Reports include product consumptions levels represented in charts comparing different events. Levels will be presented in bar graphs
         Users will be able to retrieve product consumption information to compare events and make necessary adjustments for future events.
   As a customer—would like to view the selling prices for the different package deals.
      As a system—show package details
         the following elements are required: product name, product price, availability.
         Given that clients will be able to view different packages, then they will be able to choose the most sufficient one for their event.
   As a manager—need to able to create a “Banquet Check” driven from the BEO that includes the name, room number, food and beverage consumption and number of guests so that can provide the customer with check breakdown.
      As a manager—will be able to create a check that includes details of usage in the event.
         The check will include: product usage translating to amount spent, business overheads used in event.
   As a manager—want to be able to view a report that entails the beverage consumption at equal time intervals.
      As a system—need to record and retrieve beverage consumption levels at equal intervals.
      Managers will be able to see consumption levels at different events and times.
      Given that users will have the ability to compare consumptions levels, then they will be able to make necessary adjustments for future events

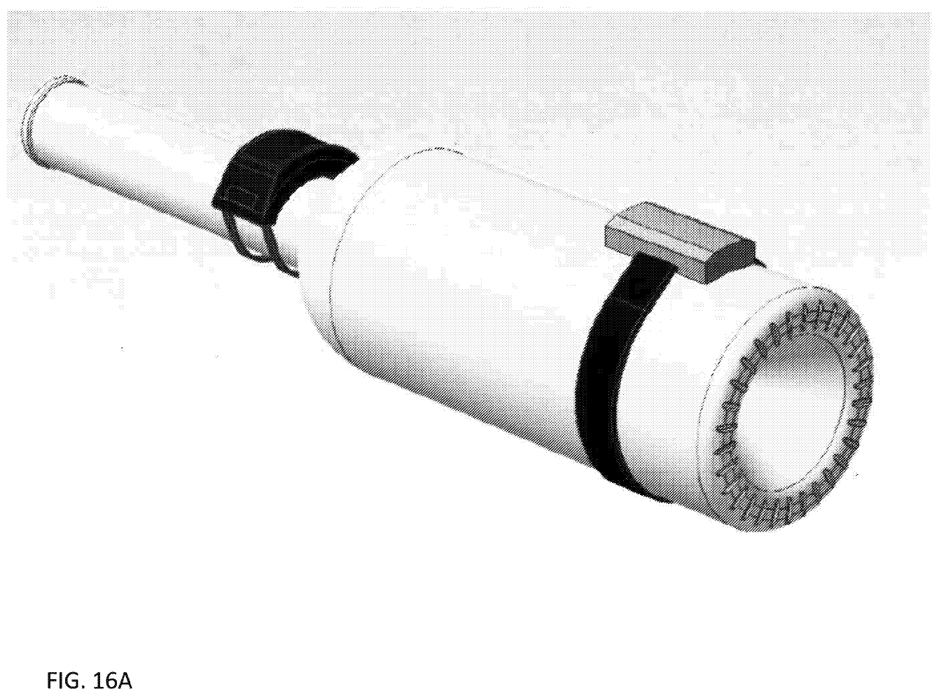

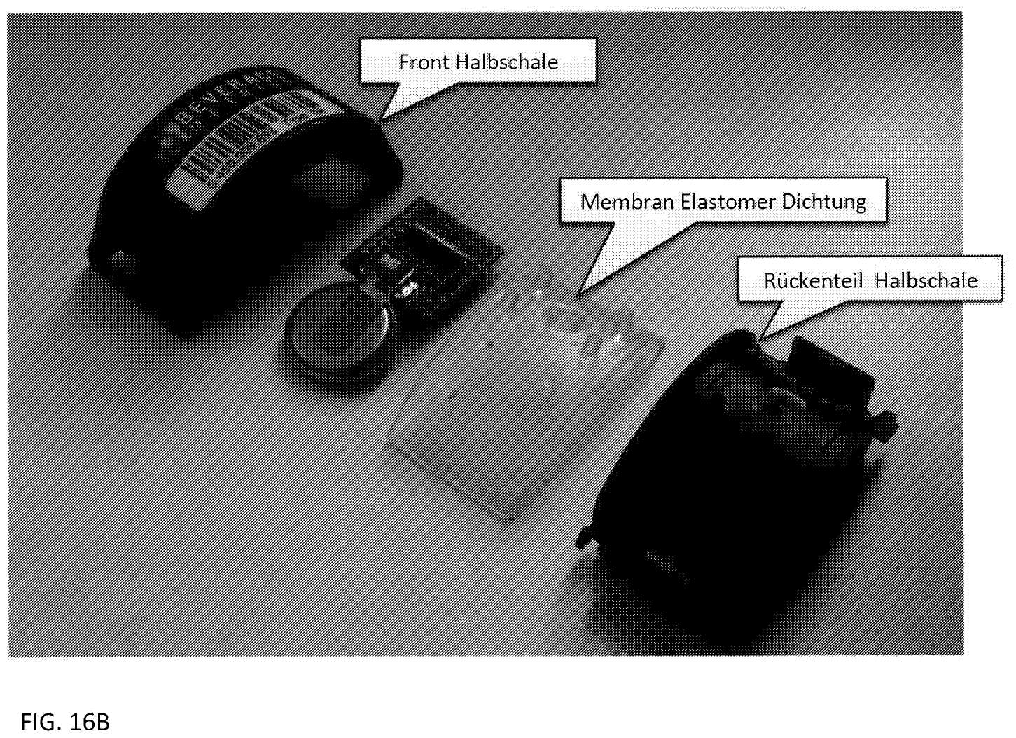

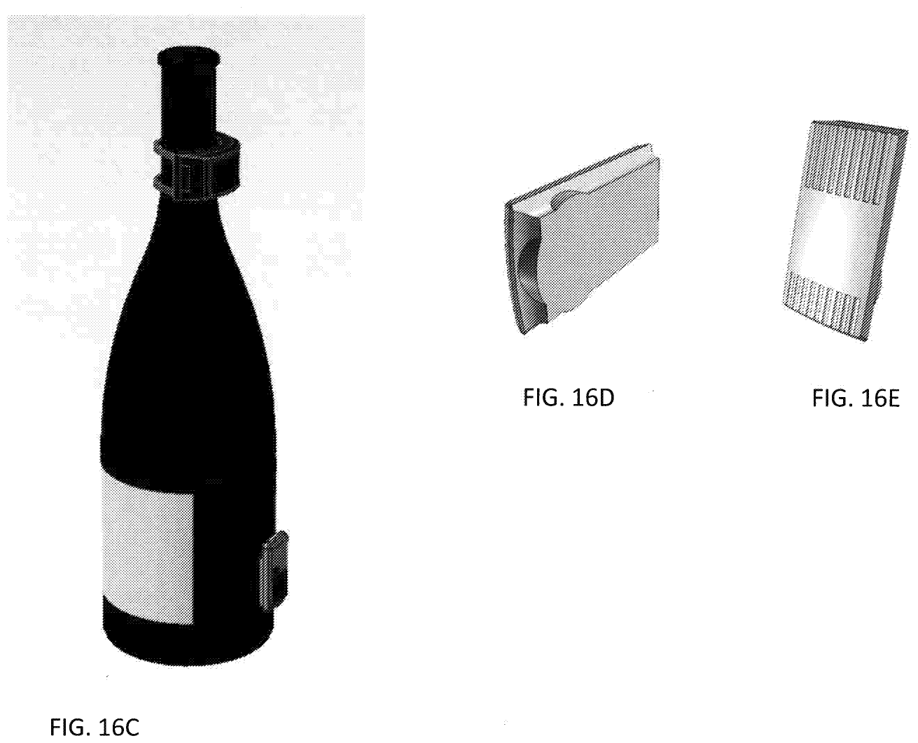

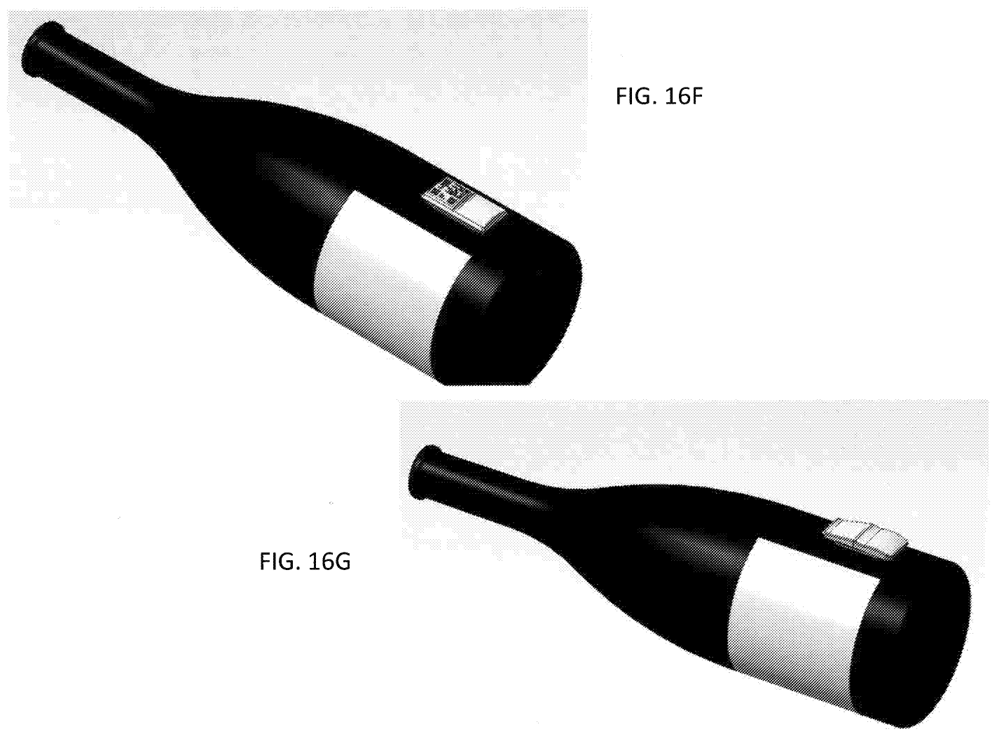

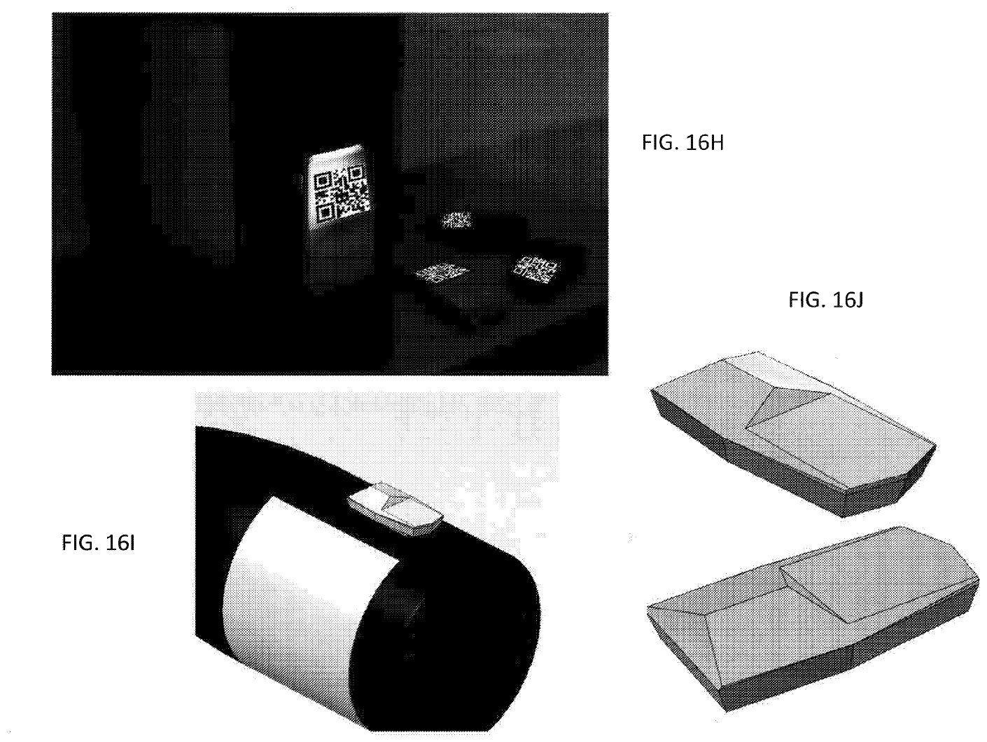

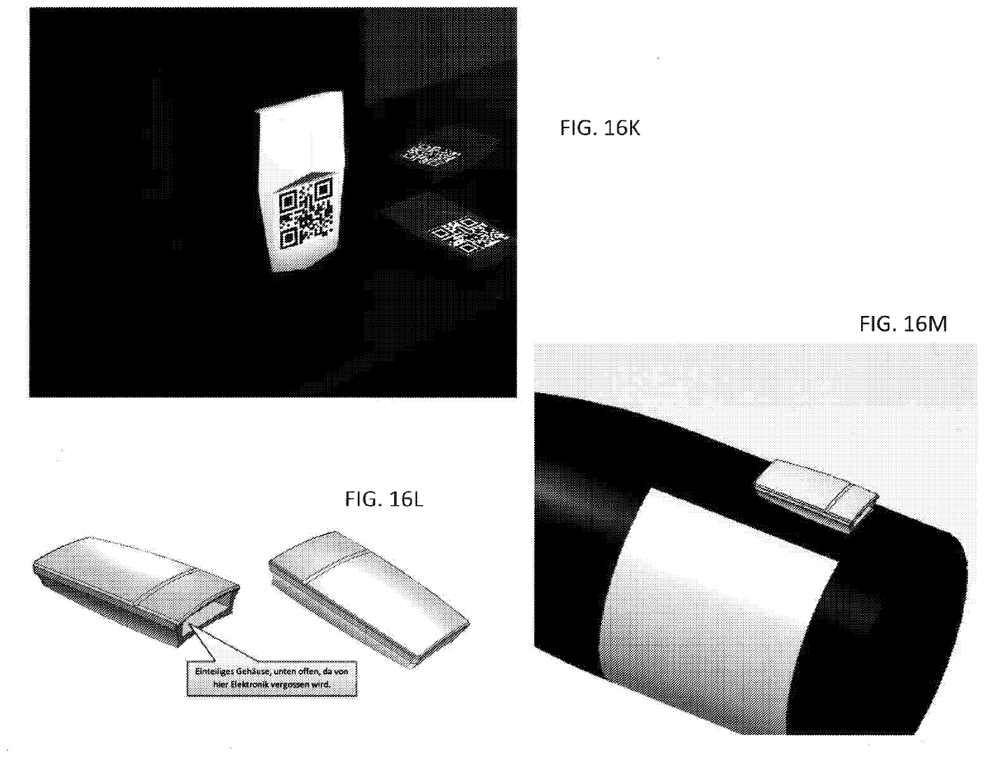

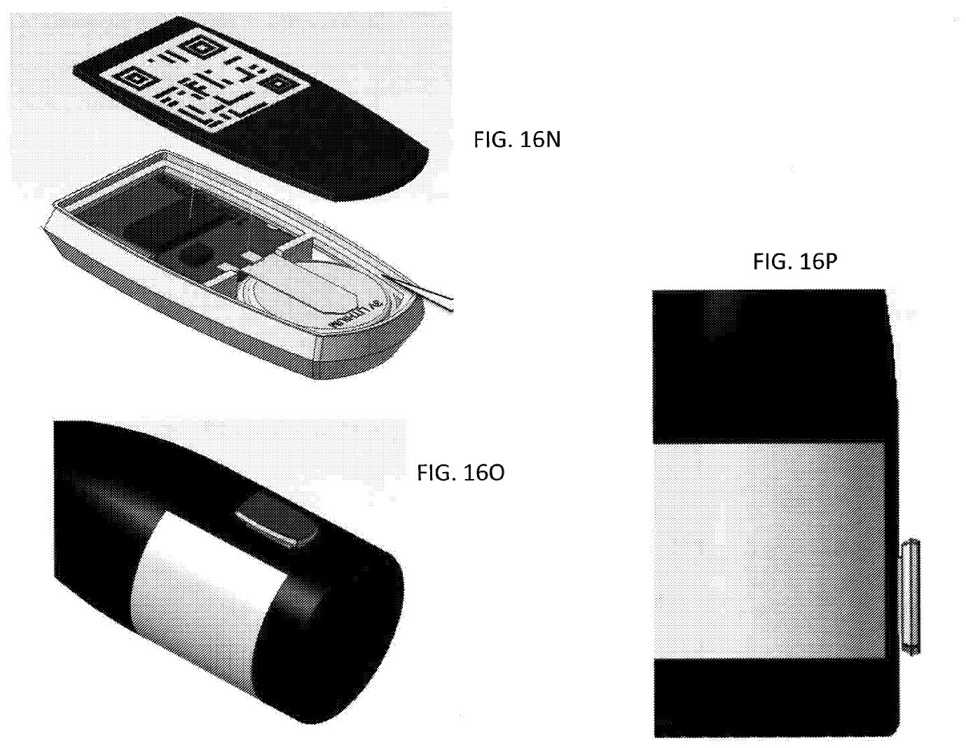

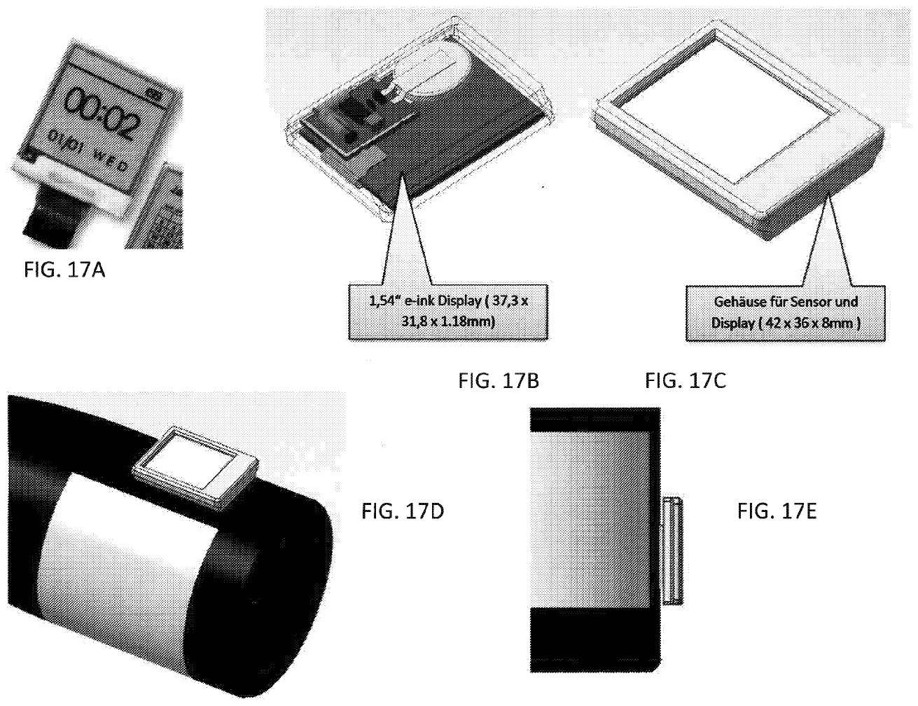

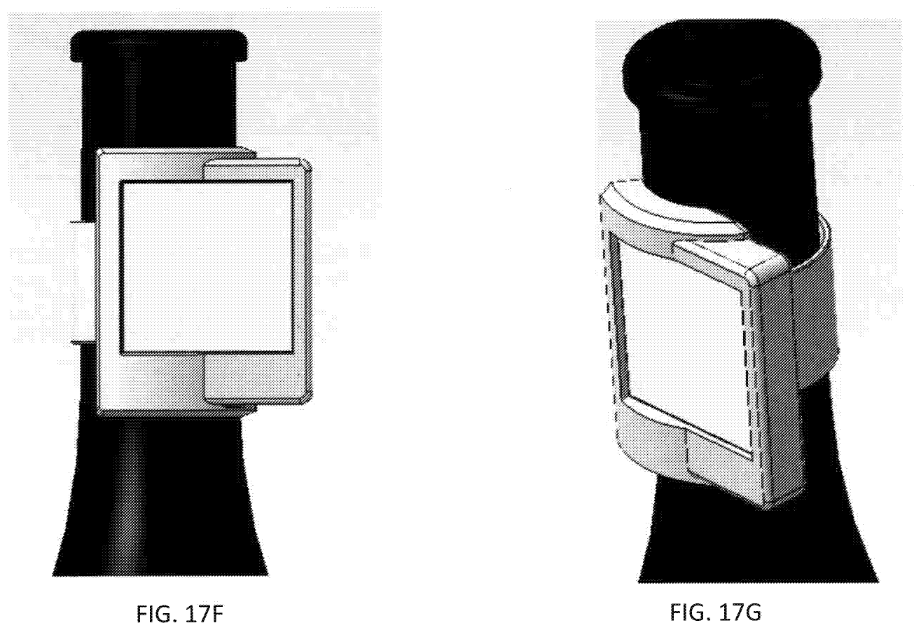

FIGS. 16A to 16P show different embodiments of a tag housing. These tag housings can be situated at various points on a bottle or object. These tag housings can be a variety of shapes, allowing for easy or noneasy removal of a tag or a battery from the tag housing. The tag housings and features of FIGS. 17A to 17G also show a variety of attachment options for associating a tag with a bottle or object. For example, a band, a rubber band, a belt-like structure, a ring-band like structure, hook-and-loop, adhesive, and other attachment options can be used.

FIGS. 17A to 17G show different embodiments of tag features, including an electronic display screen. A user can wirelessly transmit to the receiver in the tag or in the electronic display screen a value or information to display such as the fluid type or brand. Alternatively, the CPU of the tag can display the fluid level in the bottle or other information.

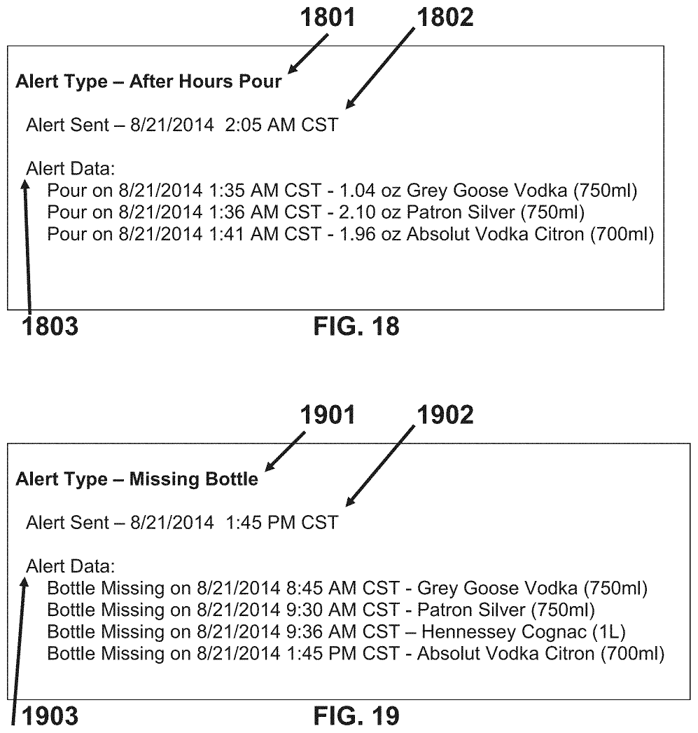

FIG. 18 shows an example alert report according to an embodiment of the present invention.

FIG. 19 shows an example alert report according to an embodiment of the present invention.

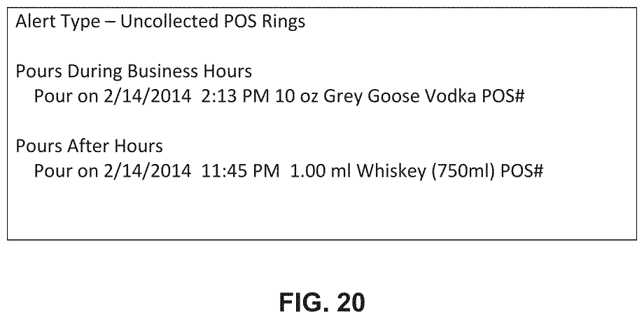

FIG. 20 shows an example alert report according to an embodiment of the present invention.

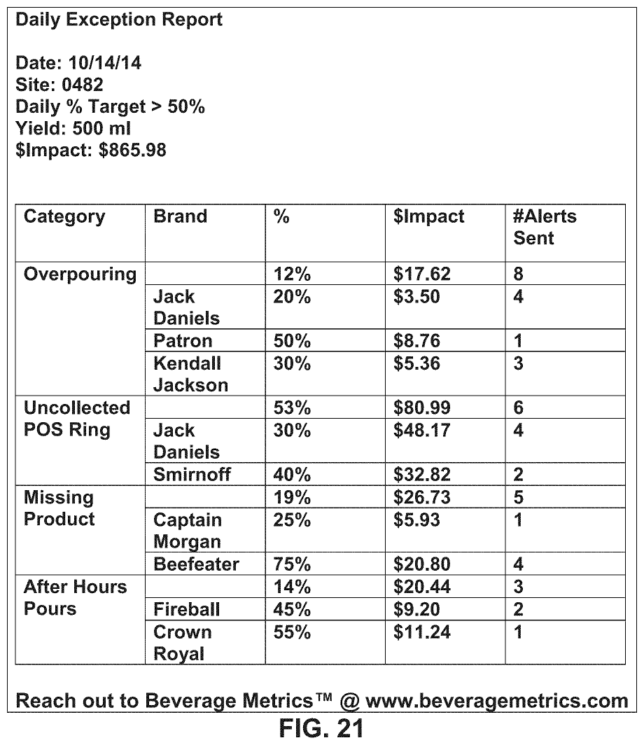

FIG. 21 shows an example exception report according to an embodiment of the present invention.

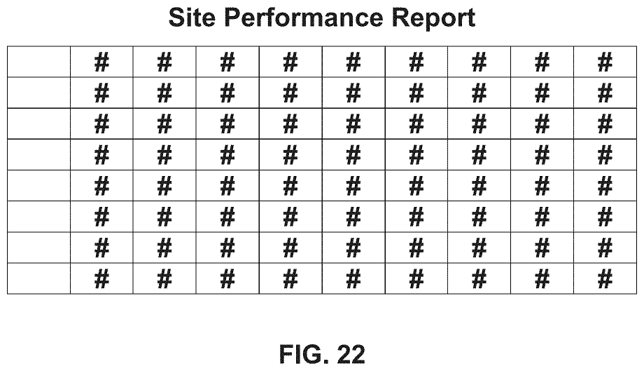

FIG. 22 shows an example site performance report according to an embodiment of the present invention.

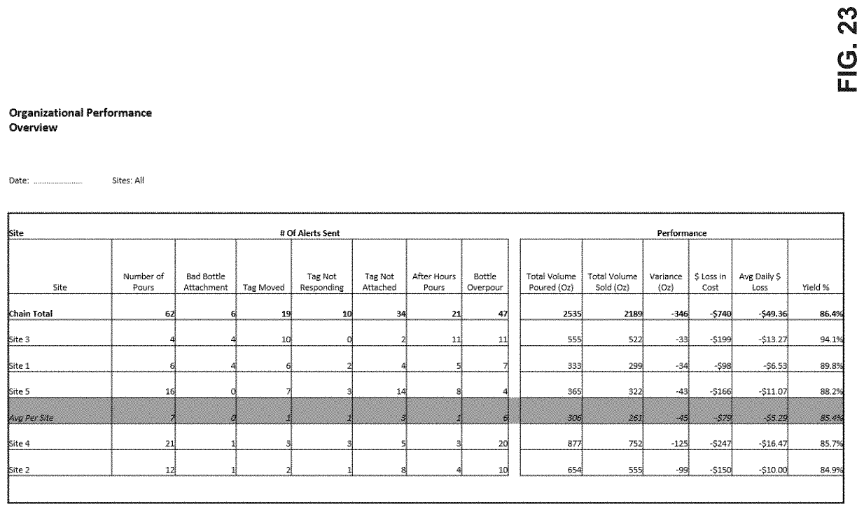

FIG. 23 shows an example organization performance overview report according to an embodiment of the present invention.

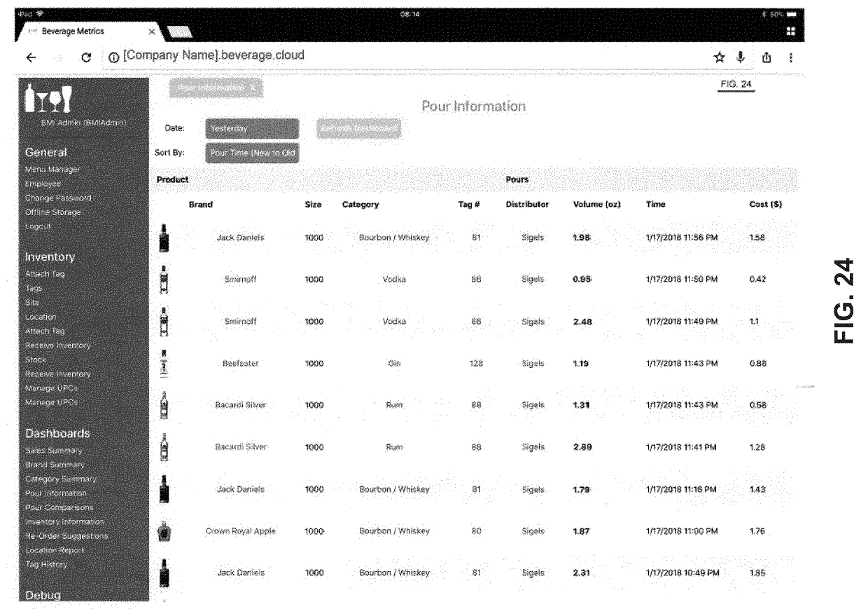

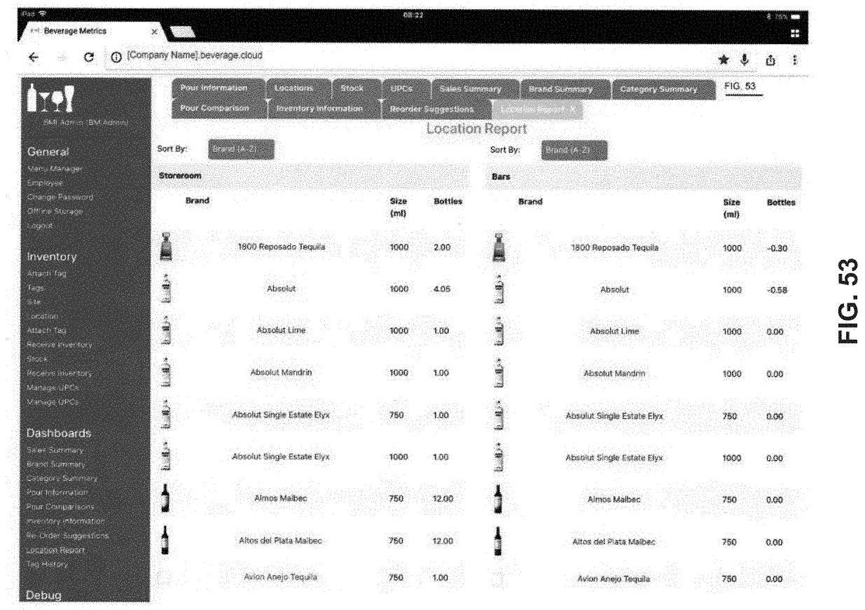

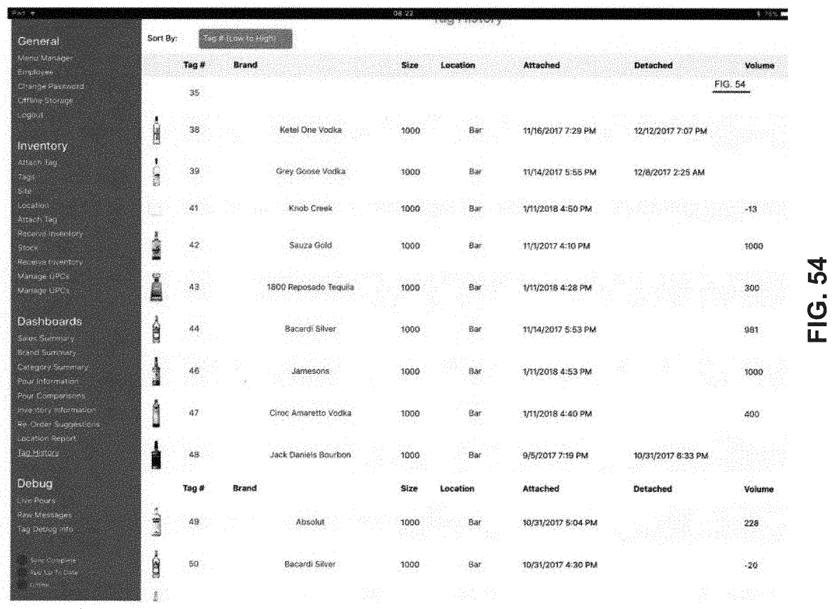

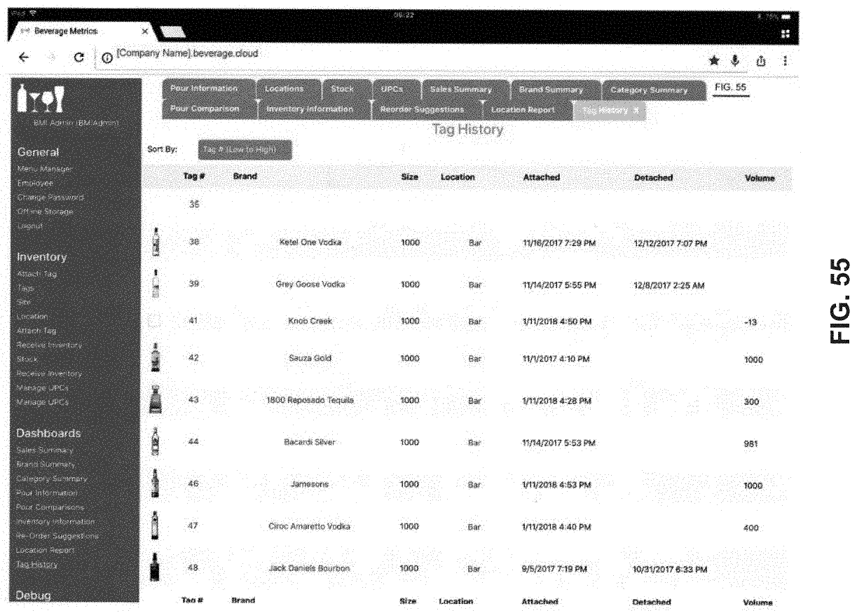

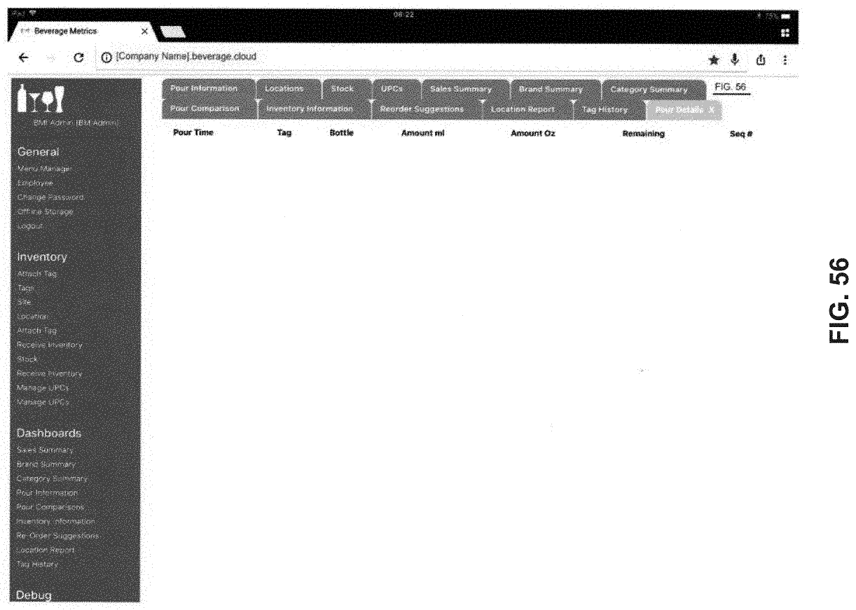

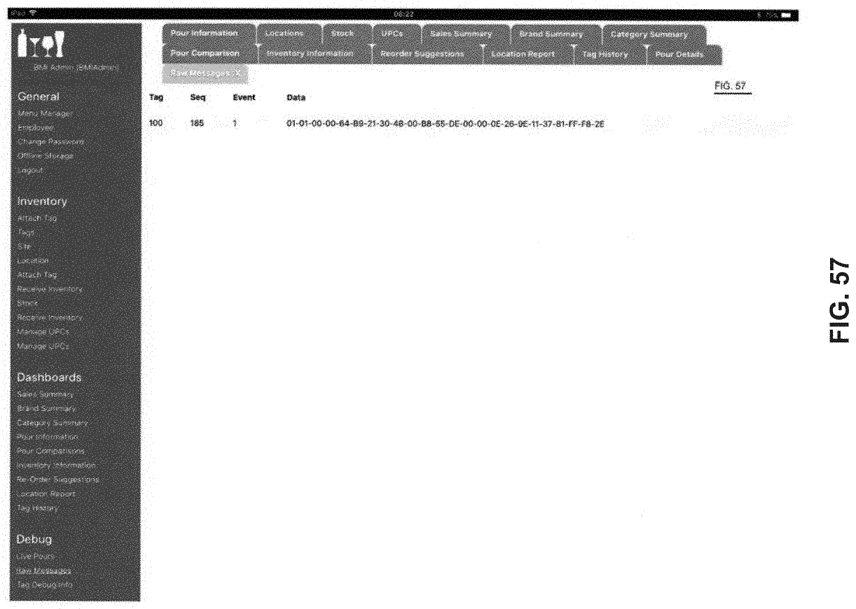

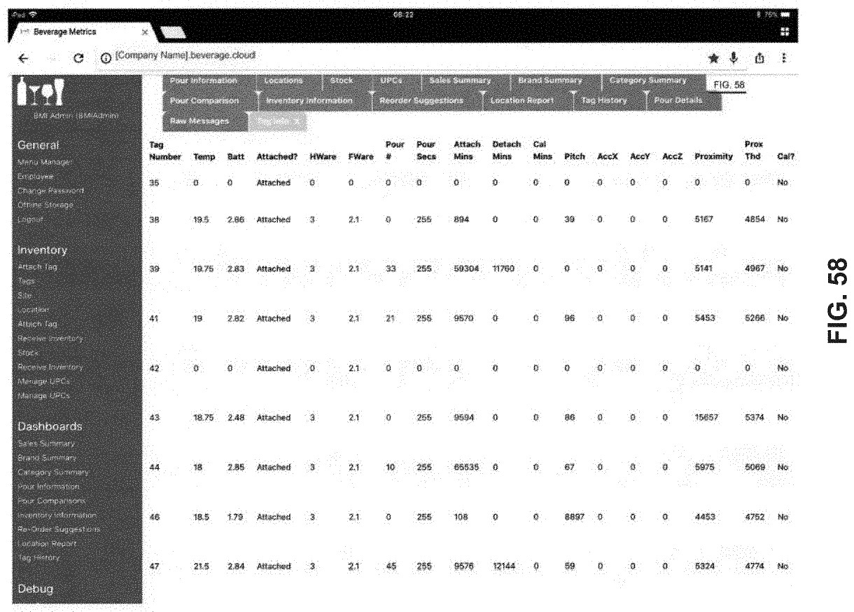

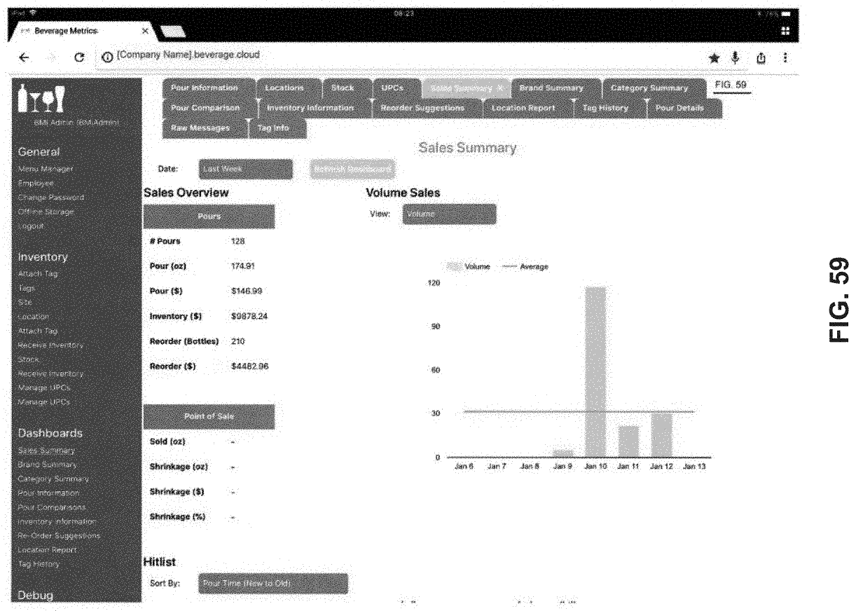

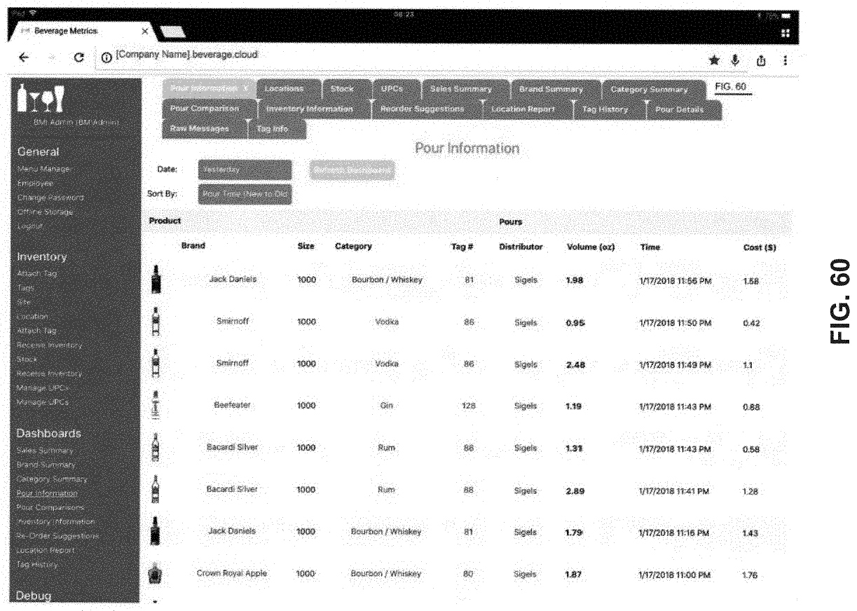

FIGS. 24 to 60 show example graphical user interface (GUI) displays according to embodiments of the present invention. In these GUIs, various reports or interactive events can be seen.

The modifications listed herein and other modifications can be made by those in the art without departing from the ambit of the invention. Although the invention has been described above with reference to specific embodiments, the invention is not limited to the above embodiments and the specific configurations shown in the drawings. For example, some components shown can be combined with each other as one embodiment, and/or a component can be divided into several subcomponents, and/or any other known or available component can be added. The operation processes are also not limited to those shown in the examples. Those skilled in the art will appreciate that the invention can be implemented in other ways without departing from the substantive features of the invention. The present embodiments are therefore to be considered in all respects as illustrative and not restrictive. Other embodiments can be utilized and derived therefrom, such that structural and logical substitutions and changes can be made without departing from the scope of this disclosure. This Specification, therefore, is not to be taken in a limiting sense, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations and/or variations of various embodiments. Combinations of the above embodiments, and other embodiments not specifically described herein, will be apparent to those of ordinary skill in the art upon reviewing the above description.

What is claimed is:

1. An apparatus, comprising:
a low-energy transmitter module;
a central processing unit having a transceiver and a memory;
a movement and acceleration sensor; and
a power source;
wherein the power source provides power to the central processing unit which controls the activation of the movement and acceleration sensor, the central processing unit storing data obtained by the movement and acceleration sensor, the data being transmitted via the transceiver to the low-energy transmitter module which then transmits outside the apparatus.

2. The apparatus of claim 1, wherein the transmissions are Bluetooth transmissions.

3. The apparatus of claim 2, wherein the apparatus is located inside a housing attached to an object.

4. The apparatus of claim 3, wherein the object is a bottle holding fluid.

5. A system, comprising:
an electrical circuit disposed in a housing situated on an object;
a reader associated with the electrical circuit, the reader reading the data transmitted by the circuit and transmitting the data to a receiver;
the receiver receiving the transmitted data and transmitting the transmitted data to a server;
wherein the transmissions of data is by at least one of: broadcast, and two-way communication.

6. The apparatus of claim 1, further comprising:
a housing, wherein the housing has an outer housing, an inner holder to hold the low-energy transmitter module the central processing unit, the movement and acceleration sensor, and the power source; and a stopper to hold contents of the inner holder steady,
wherein the housing is formed in a ring shape, a front portion of the housing allowing a view of the inner holder, and the ring shape including a band portion fittable to a bottle.
